(19) United States
(12) Patent Application Publication
(10) Pub. No.: US 2026/0110934 A1
(43) Pub. Date: Apr. 23, 2026

(54) RESIN FILM, AND DISPLAY DEVICE AND OPTICAL MEMBER INCLUDING RESIN FILM

(71) Applicant: SAMSUNG ELECTRONICS CO., LTD., Suwon-si (KR)

(72) Inventors: Yuichiro GOTO, Yokohama-shi (JP); Yuki MIYAMOTO, Yokohama-shi (JP); Yoshihiro YOKOTE, Yokohama-shi (JP); Naewon JANG, Suwon-si (KR); Wonyeop JANG, Suwon-si (KR); Seunggi KIM, Suwon-si (JP); Byoungjin CHO, Suwon-si (KR)

(73) Assignee: SAMSUNG ELECTRONICS CO., LTD., Suwon-si (KR)

(21) Appl. No.: 19/394,515

(22) Filed: Nov. 19, 2025

Related U.S. Application Data
(63) Continuation of application No. PCT/KR2025/016509, filed on Oct. 17, 2025.

(30) Foreign Application Priority Data
Oct. 17, 2024 (JP) 2024-181867

(51) Int. Cl. G02F 1/1335

(52) U.S. Cl. CPC G02F 1/133502; G02F 1/133528

(57) ABSTRACT

A resin film includes: an anti-glare layer including: a binder; light-scattering particles partially disposed in and protruding from the binder, the light-scattering particles having irregularities on surfaces thereof; and high refractive index nanoparticles on the irregularities on portions of the surfaces the light-scattering particles protruding from the binder; and a low refractive index layer on the anti-glare layer, wherein a surface of the anti-glare layer comprises flat portions and protruding portions where the portions of the light-scattering particles protrude from the flat portions.

### CROSS-REFERENCE TO RELATED APPLICATION

This application is a continuation of International Application No. PCT/KR2025/016509, filed on Oct. 17, 2025, which is based on and claims priority to Japanese Patent Application No. 2024-181867, filed on Oct. 17, 2024, in the Japanese Patent Office, the disclosures of which are incorporated by reference herein in their entireties.

### BACKGROUND

### 1. Field

The disclosure relates to a resin film with high anti-glare and improved reflectance, and a display device and an optical member each including the resin film.

### 2. Description of Related Art

Display devices, such as liquid crystal displays (LCDs), plasma display panels (PDPs), electroluminescence displays (ELDs), and field emission displays (FEDs), may provide improved visibility of images through the arrangement of an anti-reflection member on an image display surface.

### SUMMARY

According to an aspect of the disclosure, a resin film includes: an anti-glare layer including: a binder; light-scattering particles partially disposed in and protruding from the binder, the light-scattering particles having irregularities on surfaces thereof; and high refractive index nanoparticles on the irregularities on portions of the surfaces the light-scattering particles protruding from the binder; and a low refractive index layer on the anti-glare layer, wherein a surface of the anti-glare layer comprises flat portions and protruding portions where the portions of the light-scattering particles protrude from the flat portions.

According to an aspect of the disclosure, a display device includes: a display configured to display an image and comprising a resin film, wherein the resin film includes: an anti-glare layer including: a binder; light-scattering particles partially disposed in and protruding from the binder, the light-scattering particles having irregularities on surfaces thereof; and high refractive index nanoparticles on the irregularities on portions of the surfaces the light-scattering particles protruding from the binder; and a low refractive index layer on the anti-glare layer, and wherein a surface of the anti-glare layer comprises flat portions and protruding portions where the portions of the light-scattering particles protrude from the flat portions.

According to an aspect of the disclosure, an optical member includes: a substrate; and a resin film on the substrate, wherein the resin film includes: an anti-glare layer includes: a binder; light-scattering particles partially disposed in and protruding from the binder, the light-scattering particles having irregularities on surfaces thereof; and high refractive index nanoparticles on the irregularities on portions of the surfaces the light-scattering particles protruding from the binder; and a low refractive index layer on the anti-glare layer, and wherein a surface of the anti-glare layer comprises flat portions and protruding portions where the portions of the light-scattering particles protrude from the flat portions.

### BRIEF DESCRIPTION OF DRAWINGS

FIG. 1A is a diagram illustrating a display device according to an embodiment of the disclosure.

FIG. 1B is a cross-sectional view of the display device taken along line Ib-Ib of FIG. 1A.

FIG. 1C is a cross-sectional view of a display device according to an embodiment of the disclosure.

FIG. 2 is a cross-sectional view schematically illustrating an anti-reflection film according to an embodiment of the disclosure.

FIG. 3 is an enlarged view illustrating an anti-glare layer included in an anti-reflection film according to an embodiment of the disclosure.

FIG. 4 is a cross-sectional view schematically illustrating an anti-reflection film according to an embodiment of the disclosure.

FIG. 5 is a cross-sectional view schematically illustrating an anti-reflection film according to an embodiment of the disclosure.

FIG. 6A is a cross-sectional view schematically illustrating a polarizing plate according to an embodiment of the disclosure.

FIG. 6B is a cross-sectional view schematically illustrating a polarizing plate according to an embodiment of the disclosure.

FIG. 7A is a flowchart illustrating a method of manufacturing an anti-reflection film, according to an embodiment of the disclosure.

FIG. 7B is a flowchart illustrating a method of manufacturing an anti-glare layer and a low refractive index layer, according to an embodiment of the disclosure.

### DETAILED DESCRIPTION

As the present description allows for various changes and numerous embodiments of the disclosure, certain embodiments of the disclosure will be illustrated in the drawings and described in detail in the written description. Effects and features of the disclosure, and methods of achieving them will be clarified with reference to embodiments described below in detail with reference to the drawings. However, the disclosure is not limited to the following embodiments and may be embodied in various forms.

Hereinafter, embodiments will be described in detail with reference to the accompanying drawings. When describing embodiments with reference to the accompanying drawings, the same or corresponding elements are denoted by the same reference numerals, and redundant descriptions thereof are omitted.

It will be understood that although the terms “first,” “second,” etc. may be used herein to describe various elements, these elements should not be limited by these terms. These terms are only used to distinguish one element from another.

Operations constituting methods may be performed in any suitable order unless otherwise indicated herein or otherwise clearly contradicted by context, and are not necessarily limited to the stated order.

The singular forms as used herein are intended to include the plural forms as well unless the context clearly indicates otherwise.

The use of the term “the” and similar demonstratives may correspond to both the singular and the plural.

It will be further understood that the terms “include” and/or “comprise” used herein specify the presence of stated features or elements, but do not preclude the presence or addition of one or more other features or elements.

It will be further understood that, when a layer, region, or element is referred to as being “on” another layer, region, or element, it may be directly or indirectly on the other layer, region, or element. That is, for example, intervening layers, regions, or elements may be present.

It will be further understood that when layers, regions, or elements are referred to as being connected to each other, they may be directly connected to each other or indirectly connected to each other with intervening layers, regions, or elements therebetween. For example, when layers, regions, or elements are referred to as being electrically connected to each other, they may be directly electrically connected to each other or indirectly electrically connected to each other with intervening layers, regions, or elements therebetween.

As used herein, the expression “A and/or B” indicates only A, only B, or both A and B. The expression “at least one of A and B” indicates only A, only B, or both A and B.

In the present specification, the x-axis, the y-axis, and the z-axis are not limited to three axes of the rectangular coordinate system and may be interpreted in a broader sense. For example, the x-axis, the y-axis, and the z-axis may be perpendicular to one another or may represent different directions that are not perpendicular to one another.

The terms “about” or “approximately” used herein to refer to any numerical value may mean including numerical values within a range generally acceptable in the art due to measurement limitations or errors. For example, “about” may mean including values within a range of +30%, +20%, +10%, or +5% of any numerical value.

In the disclosure, the expression that “a component B is directly disposed on a component A” may mean that no separate adhesion layer or adhesion member is disposed between the component A and the component B. In this case, the component B may be formed on a base surface provided by the component A through a continuous process after the component A is formed.

In the disclosure, the expression that “A and B overlap each other” may indicate that, when a plane (e.g., an xy plane) perpendicular to one direction (e.g., a z-axis direction) is viewed from the one direction (e.g., the z-axis direction), at least a portion of A and at least a portion of B are disposed to overlap each other on the plane.

In addition, the terms “unit” and “module” as used herein mean units that process at least one function or operation, and may be implemented as hardware, software, or a combination of hardware and software.

When a certain embodiment of the disclosure may be implemented differently, a specific process order may be performed differently from the described order. For example, two consecutively described processes may be performed substantially at the same time or performed in an order opposite to the stated order.

Also, sizes of elements in the drawings may be exaggerated or reduced for convenience of explanation. For example, because sizes and thicknesses of elements in the drawings are arbitrarily illustrated for convenience of explanation, the disclosure is not necessarily limited thereto.

In addition, connecting lines or connecting members illustrated in the drawings are intended to represent example functional connections and/or physical or circuit connections. In an actual device, it may appear as a variety of alternative or additional functional, physical, or circuit connections.

Various methods are being attempted to suppress the influence of external light on display devices, etc. by improving anti-glare by applying an optical member having an anti-glare layer. However, to improve the visibility of display devices, low reflectance is required along with high anti-glare. The disclosure provides a resin film with excellent anti-glare and low reflectance, and an optical member and a display device each including the resin film. The disclosure provides a resin film with improved chromaticity, and an optical member and a display device each including the resin film. The technical problems to be solved by the disclosure are not limited to those described above, and other technical problems that are not mentioned herein will be clearly understood by those of ordinary skill in the art from the following description. Hereinafter, a resin film, an optical member, and a display device, according to embodiments of the disclosure, will be described in detail with reference to the accompanying drawings.

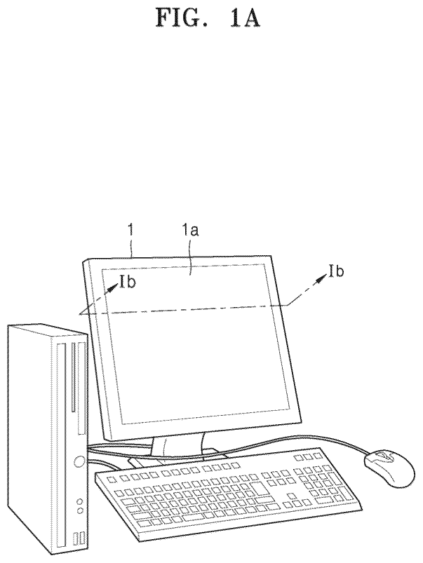

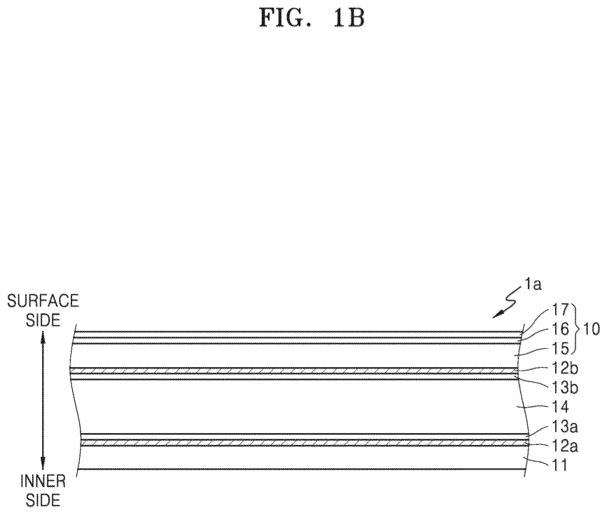

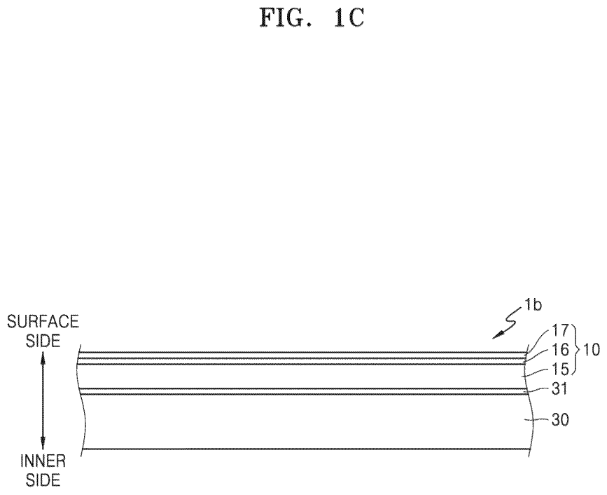

FIG. 1A is a diagram schematically illustrating a display device 1 according to an embodiment of the disclosure.

Referring to FIG. 1A, the display device 1 according to an embodiment of the disclosure may be a liquid crystal display for a personal computer (PC) or a liquid crystal television (TV). The display device 1 may display an image on a liquid crystal panel 1a.

### Liquid Crystal Panel

FIG. 1B is a cross-sectional view of the display device 1 taken along line Ib-Ib of FIG. 1A. Specifically, FIG. 1B is a diagram illustrating an example of a cross-sectional configuration of the liquid crystal panel 1a according to an embodiment of the disclosure.

The liquid crystal panel 1a is an example of a display displaying an image. The liquid crystal panel 1a according to an embodiment of the disclosure may be, for example, a vertical alignment (VA)-type liquid crystal panel. In an embodiment of the disclosure, the liquid crystal panel 1a may include a protection film 11, a first polarizing film 12a, a first retardation film 13a, a liquid crystal 14, a second retardation film 13b, a second polarizing film 12b, and an anti-reflection film 10. The protection film 11, the first polarizing film 12a, the first retardation film 13a, the liquid crystal 14, the second retardation film 13b, the second polarizing film 12b, and the anti-reflection film 10 may be sequentially stacked in this stated order along a direction from the inner side of the liquid crystal panel 1a toward the surface side of the liquid crystal panel 1a.

Hereinafter, for convenience of explanation, the first polarizing film 12a and the second polarizing film 12b may be collectively or individually referred to as a polarizing film. Similarly, the first retardation film 13a and the second retardation film 13b may be collectively or individually referred to as a retardation film.

As described below, the anti-reflection film 10 may include a substrate 15, an anti-glare layer 16, and a low refractive index layer 17, which are sequentially stacked in this stated order along a direction from the inner side of the liquid crystal panel 1a toward the surface side thereof.

In the disclosure, a resin film may refer to a stack structure in which the anti-glare layer 16 and the low refractive index layer 17 are stacked. In an embodiment of the disclosure, the resin film may refer to the anti-reflection film 10 that includes the anti-glare layer 16, the low refractive index layer 17, and the substrate 15.

The protection film 11 may protect the polarizing film. The protection film 11 may be bonded to the polarizing film by using an ultraviolet (UV) adhesive or the like. The protection film 11 may include a resin film including triacetylcellulose (TAC), polyethylene terephthalate (PET), polymethylmethacrylate (PMMA), cycloolefin polymer (COP), etc.

The first polarizing film 12a and the second polarizing film 12b are an example of a polarizing element for polarizing light. A polarization direction of the first polarizing film 12a may be perpendicular to a polarization direction of the second polarizing film 12b. In an embodiment of the disclosure, the first polarizing film 12a and the second polarizing film 12b may each include a resin film in which iodine compound molecules are included in polyvinyl alcohol (PVA). In an embodiment of the disclosure, the first polarizing film 12a and the second polarizing film 12b may each have a structure in which resin films in which iodine compound molecules are included in PVA are bonded to each other with a resin film including TAC therebetween. Because the resin film includes iodine compound molecules, light passing through the resin film may be polarized.

The retardation film may compensate for viewing angle dependence of the liquid crystal panel 1a. Light passing through the liquid crystal 14 may change a polarization state from linearly polarized light to elliptically polarized light. For example, when the liquid crystal panel 1a displays black, the liquid crystal panel 1a may appear black when viewed from a direction perpendicular to the liquid crystal panel 1a, but a retardation of the liquid crystal 14 may occur when the liquid crystal panel 1a is viewed from an inclined direction. In addition, because an axis of the first polarizing film 12a and an axis of the second polarizing film 12b do not form 90°, light leakage may occur and contrast may deteriorate. That is, viewing angle dependence may occur in the liquid crystal panel 1a. The retardation film may convert the elliptically polarized light into the linearly polarized light. Accordingly, the retardation film may compensate for viewing angle dependence of the liquid crystal panel 1a.

The liquid crystal 14 may be electrically connected to a power source. When a voltage is applied to the liquid crystal 14 by the power source, the arrangement direction of the liquid crystal 14 may change, and thus, a light transmission state may be controlled.

In the case of a VA-type liquid crystal panel, when no voltage is applied to the liquid crystal 14 (voltage OFF), liquid crystal molecules may be arranged in a direction perpendicular to the panel (e.g., a vertical direction in FIG. 1B). In this case, when light is radiated from the inner side of the liquid crystal panel 1a, the light may pass through the protection film 11 as it is and may then pass through the first polarizing film 12a, so that the light is polarized. The polarized light may pass through the liquid crystal 14 as it is. However, the second polarizing film 12b may block the polarized light because the polarization direction of the second polarizing film 12b is different from the polarization direction of the polarized light having passed through the first polarizing film 12a. In this case, a user who views the liquid crystal panel 1a may not recognize the radiated light. That is, when no voltage is applied to the liquid crystal 14, the color of the liquid crystal 14 becomes “black.”

In contrast, when a maximum voltage is applied to the liquid crystal 14, liquid crystal molecules may be arranged in a direction parallel to the panel (e.g., a direction perpendicular to the vertical direction). The direction of the polarized light having passed through the first polarizing film 12a may be rotated by 90° due to interaction with the liquid crystal 14. Accordingly, the second polarizing film 12b does not block the polarized light but transmits the polarized light. In this case, the user who views the liquid crystal panel 1a may recognize the polarized light. That is, when the maximum voltage is applied to the liquid crystal 14, the color of the liquid crystal 14 becomes “white.” In addition, the voltage may have a value between the voltage OFF and the maximum voltage. In this case, the liquid crystal 14 may be in a state between the direction perpendicular to the panel and the direction parallel to the panel. That is, the liquid crystal 14 may be arranged in an inclined direction. In this state, the color of the liquid crystal 14 becomes “gray.” Therefore, by adjusting the voltage applied to the liquid crystal 14 between the voltage OFF and the maximum voltage, intermediate grayscales other than black and white may be expressed. This may enable the liquid crystal panel 1a to display an image.

Furthermore, in an embodiment of the disclosure, a color image may be displayed by using a color filter.

### Organic Electroluminescence (EL) Panel

FIG. 1C is a cross-sectional view of a display device 1 according to an embodiment of the disclosure. FIG. 1C is a cross-sectional view corresponding to FIG. 1B in the case that the display device 1 includes an organic electroluminescence (EL) panel 1b instead of the liquid crystal panel 1a described above.

The organic EL panel 1b is an example of a display displaying an image. The organic EL panel 1b may have a structure in which an anti-reflection film 10 is bonded to an organic EL panel unit 30 by an adhesive layer 31. The adhesive layer 31 may include a visible light absorbing dye that selectively absorbs light of a particular wavelength so as to reduce reflectance or chromaticity of the organic EL panel 1b. The organic EL panel unit 30, the adhesive layer 31, and the anti-reflection film 10 may be sequentially stacked in this stated order along a direction from the inner side of the organic EL panel 1b toward the surface side thereof. As in FIG. 1B, the anti-reflection film 10 may include a substrate 15, an anti-glare layer 16, and a low refractive index layer 17, which are sequentially stacked in this stated order along a direction from the inner side of the organic EL panel 1b toward the surface side thereof.

### Anti-Reflection Film

Hereinafter, the respective layers included in the anti-reflection film 10 according to an embodiment of the disclosure are described.

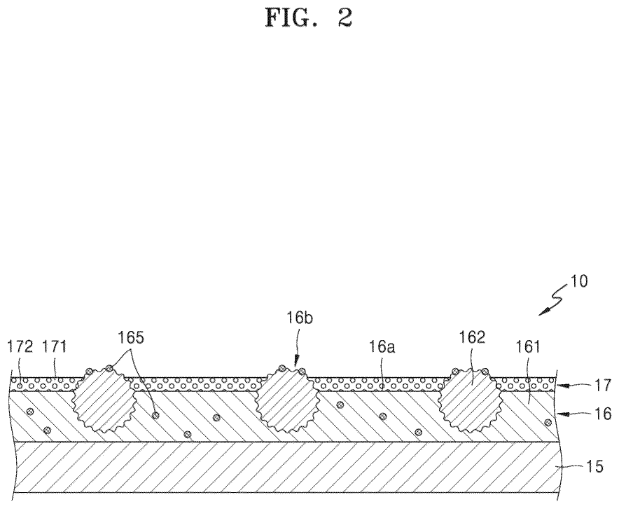

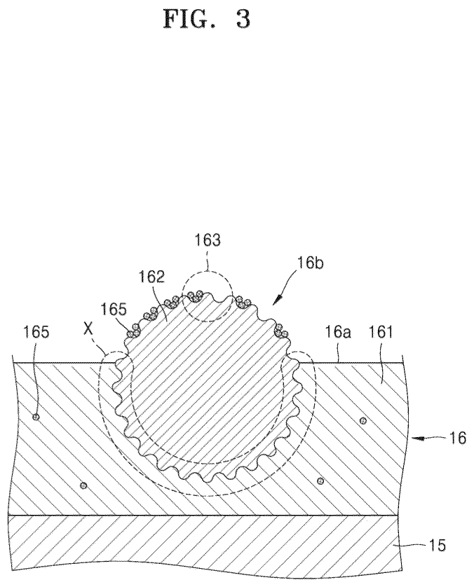

FIG. 2 is a cross-sectional view schematically illustrating the anti-reflection film 10 according to an embodiment of the disclosure. Specifically, FIG. 2 is a cross-sectional view of the anti-reflection film 10 taken along the stacking direction of the respective layers. FIG. 3 is an enlarged view illustrating the anti-glare layer 16 included in the anti-reflection film 10 according to an embodiment of the disclosure.

In the case of the liquid crystal panel (see 1a of FIG. 1B), the anti-reflection film 10 may be provided on the second polarizing film (see 12b of FIG. 1B), as described above. In the case of the organic EL panel (see 1b of FIG. 1C), the anti-reflection film 10 may be provided on the adhesive layer (see 31 of FIG. 1C), as described above. Hereinafter, a case in which the anti-reflection film 10 is used in the liquid crystal panel (see 1a of FIG. 1B) is described.

In an embodiment of the disclosure, the anti-reflection film 10 may include the substrate 15, the anti-glare layer 16 provided on the substrate 15, the low refractive index layer 17 provided on the anti-glare layer 16.

### Substrate

The substrate 15 may be a support on which the anti-glare layer 16 and the low refractive index layer 17 are formed.

In an embodiment of the disclosure, the substrate 15 may include a material with high light transmittance. For example, the substrate 15 may have a total light transmittance of 85% or more. In an embodiment of the disclosure, the substrate 15 may include TAC, PET, PMMA, or COP. When the substrate 15 includes PET, colored spots or moire patterns may occur when the substrate 15 is bonded to the second polarizing film 12b. Accordingly, in this case, the substrate 15 may include a super retardation film (SRF) manufactured by stretching PET to have high birefringence. In an embodiment of the disclosure, the thickness of the substrate 15 may be about 20 μm to about 200 μm. To ensure adhesion with the anti-glare layer 16, an easy-adhesion layer may be formed on the surface of the substrate 15. When the easy-adhesion layer is formed on the surface of the substrate 15, the difference in refractive index between the easy-adhesion layer and a binder 161 to be described below may be small.

An upper limit of an inner haze value in a visible light region (e.g., light having a wavelength of 380 nm to 780 nm) of the substrate 15 may be 0.8% or less, 0.5% or less, or 0.3% or less. A lower limit of the inner haze value in the visible light region of the substrate 15 is not particularly limited, but in an embodiment of the disclosure, the lower limit may be 0.05% or more. When the inner haze value in the visible light region of the substrate 15 is high, there may be a risk that specular component excluded (SCE) of the anti-reflection film 10 increases and specular component included (SCI) or reflection chromaticity (a*/b*) deteriorates. This trend is particularly noticeable when the anti-glare layer 16 includes highly scattering particles (e.g., light-scattering particles 162 to be described below). The SCE of the anti-reflection film 10 may refer to reflectance excluding specular reflection of the anti-reflection film 10, and the SCI of the anti-reflection film 10 may refer to reflectance including both diffuse reflection and specular reflection of the anti-reflection film 10.

The inner haze value of the substrate 15 may be obtained by, for example, measuring the haze while the substrate 15 is sandwiched between glasses by using a liquid having a refractive index that is similar to a refractive index of the substrate 15. In addition, the wavelength dependence of the inner haze value of the substrate 15 may be measured by using a spectroscopic haze meter (e.g., SH7000 manufactured by Nippon Denshoku Kogyo Co., Ltd.).

### Anti-Glare Layer

The anti-glare layer 16 may scatter light incident from the outside (external light) to suppress the external light from being mirrored on the liquid crystal panel (see 1a of FIG. 1B) and improve anti-glare of the anti-reflection film 10.

The anti-glare layer 16 according to an embodiment of the disclosure may include a binder 161, light-scattering particles 162 partially disposed in and protruding from the binder 161, and high refractive index nanoparticles 165. As described below, in an embodiment of the disclosure, the anti-glare layer 16 may be formed by using a coating solution including the binder 161, the light-scattering particles 162, and the high refractive index nanoparticles 165. In addition, the anti-glare layer 16 may include, in addition to the binder 161, the light-scattering particles 162, and the high refractive index nanoparticles 165, other additives such as a polymerization initiator, a chain transfer agent, a leveling agent, an anti-foaming agent, a surface modifier, an UV absorber, a thickener, an antioxidant, a flame retardant, an anti-static agent, etc.

As illustrated in FIGS. 2 and 3, the anti-glare layer 16 according to an embodiment of the disclosure may include the binder 161 as a main component, and may include a flat portion 16a having a flat surface shape and a protruding portion 16b where a portion of the light-scattering particles 162 protrudes from the surface of the flat portion 16a. In addition, the protruding portion 16b may protrude from the surface of the flat portion 16a toward the surface side of the liquid crystal panel (see 1a of FIG. 1B) (e.g., toward the upper side in FIG. 1B). The high refractive index nanoparticles 165 may be deposited on the irregular shape of the light-scattering particles 162 in the portion protruding from the surface of the flat portion 16a.

External light may be scattered by the protruding shape of the light-scattering particles 162. The light-scattering particles 162 may have irregularities 163 on surfaces thereof, and the high refractive index nanoparticles 165 may be deposited on the irregularities 163. External light may be scattered more easily by the irregularities 163 formed on the surfaces of the light-scattering particles 162. In addition, external light may be scattered more easily by the high refractive index nanoparticles 165 deposited on the irregularities 163 of the light-scattering particles 162, and thus, anti-glare may be greatly improved.

A shape in which the high refractive index nanoparticles 165 are deposited on the irregularities 163 of the light-scattering particles 162 may be confirmed by observation through a scanning electron microscope (SEM) or the like. As schematically illustrated in FIG. 3, which is an enlarged cross-section of the anti-glare layer 16, a plurality of high refractive index nanoparticles 165 may be deposited in one concave portion.

The binder 161 may include a resin that disperses the light-scattering particles 162. In an embodiment of the disclosure, the resin included in the binder 161 may be a curable resin. In an embodiment of the disclosure, a photocurable resin among curable resins may be used to increase the mechanical strength of the anti-glare layer 16 and obtain good optical characteristics.

In an embodiment of the disclosure, the photocurable resin may include (meth)acrylic-based resin, urethane-based resin, (meth)acrylic urethane-based resin, epoxy-based resin, silicone-based resin, etc. In an embodiment of the disclosure, the photocurable resin may include a compound (including a monomer, an oligomer, etc.) having one or more unsaturated bonds. Examples of the compound having one unsaturated bond may include ethyl (meth)acrylate, ethylhexyl (meth)acrylate, styrene, methylstyrene, and N-vinylpyrrolidone. Examples of the compound having a plurality of unsaturated bonds may include trimethylolpropane tri(meth)acrylate, tripropylene glycol di(meth)acrylate, diethylene glycol di(meth)acrylate, pentaerythritol tri(meth)acrylate, pentaerythritol tetra(meth)acrylate, dipentaerythritol hexa(meth)acrylate, dipentaerythritol penta(meth)acrylate, 1,6-hexanediol di(meth)acrylate, and neopentyl glycol di(meth)acrylate. In addition, examples of the oligomer having a plurality of unsaturated bonds may include urethane (meth)acrylate, epoxy (meth)acrylate, polyether(meth)acrylate, and polyester (meth)acrylate. The compounds described above may be used alone or in combination of two or more thereof.

The binder 161 may include a resin having good compatibility with the high refractive index nanoparticles 165. When the binder 161 includes the resin having good compatibility, the high refractive index nanoparticles 165 do not cause agglomeration within the anti-glare layer 16 and may lower the inner haze of the anti-glare layer 16, and thus, the reflectance of the anti-reflection film 10 may be reduced. In an embodiment of the disclosure, the resin having good compatibility may be a resin using a urethane (meth)acrylate oligomer, but embodiments of the disclosure are not limited thereto. In an embodiment of the disclosure, the resin having good compatibility may include aliphatic urethane acrylates such as EBECRYL 5129 and KRM8452 manufactured by Daicel Allnex Co., Ltd., U-6LPA manufactured by Shin-Nakamura Chemical Industry Co., Ltd., UA-306H manufactured by Kyoeisha Chemical Co., Ltd., and 8UX-122A manufactured by Taisei Fine Chemical Co., Ltd.

When the binder 161 includes the resin as described above, the inner haze value of the anti-glare layer 16 may be 2.5% or less. An inner haze value of a 80-μm-thick film manufactured by mixing the binder 161 with the high refractive index nanoparticles 165 to have a mass ratio of 90:10 may be 2.0% or less.

In addition, the resin included in the binder 161 may be the same resin as a resin included in a binder 171 included in the low refractive index layer 17 to be described below.

In an embodiment of the disclosure, the refractive index of the binder 161 may be 1.45 or more or 1.50 or more. In an embodiment of the disclosure, the refractive index of the binder 161 may be 1.60 or less. In addition, the refractive index of the composition including the binder 161 and the high refractive index nanoparticles 165 may be 1.50 or more or 1.55 or more.

As described above, the light-scattering particles 162 may include the portion protruding from the surface of the flat portion 16a.

In the disclosure, the average particle diameter of the light-scattering particles 162 may be set so that a portion of the light-scattering particles 162 may protrude from the surface of the flat portion 16a to form the protruding portion 16b. In an embodiment of the disclosure, the average particle diameter of the light-scattering particles 162 may be about 1 μm to about 10 μm. In an embodiment of the disclosure, the average particle diameter of the light-scattering particles 162 may be about 1 μm to about 5 μm. In this case, it is possible to suppress glare caused by image light that may be generated by the irregularities 163 formed in the surfaces of the light-scattering particles 162 included in the anti-glare layer 16. When the average particle diameter of the light-scattering particles 162 is less than 1 μm, it becomes difficult for the light-scattering particles 162 to protrude from the surface of the flat portion 16a, and thus, the effect of suppressing a phenomenon that light is mirrored on a screen by scattering light due to the protruding portion 16b may be insufficient. When the average particle diameter of the light-scattering particles 162 is greater than 10 μm, the size of the protruding portion 16b in the anti-glare layer 16 increases, and thus, when applied to an image display device, glare caused by image light easily occurs.

In addition, the light-scattering particles 162 may not include coarse particles. In an embodiment of the disclosure, the light-scattering particles 162 may include 1 mass % or less of particles having a diameter of 20 μm or more, 0.5 mass % or less of particles having a diameter of 16 μm or more, and 0.2 mass % or less of particles having a diameter of 12 μm or more. When the light-scattering particles 162 include a large number of coarse particles, the coating property of the low refractive index layer 17 for the anti-glare layer 16 is reduced, and thus, a spot-shaped appearance defect centered on the coarse particles may easily occur in the low refractive index layer 17.

In the disclosure, the particle size distribution of the light-scattering particles 162 may be measured by using a Coulter counter. The light-scattering particles 162 may have a narrow particle size distribution. In an embodiment of the disclosure, when the particle size distribution of the light-scattering particles 162 is measured, a coefficient of variation (a CV value) may be 35% or less, 30% or less, or 25% or less. A lower limit of the CV value is not particularly limited, but in an embodiment of the disclosure, the CV value may be 5% or more. When the CV value of the particle size distribution of the light-scattering particles 162 is greater than 35%, the irregularities of the surface of the anti-glare layer 16 including the light-scattering particles 162 may be non-uniform. As a result, the coating property of the low refractive index layer 17 for the anti-glare layer 16 is reduced, and thus, when the low refractive index layer 17 is coated, a spot-shaped coating defect may easily occur. In addition, wear resistance of the surface of the anti-reflection film 10 may be reduced.

In an embodiment of the disclosure, the anti-glare layer 16 may include two or more types of light-scattering particles 162 having different average particle diameters. In an embodiment of the disclosure, the anti-glare layer 16 may include the light-scattering particles 162 described above and other particles having a different average particle diameter from the light-scattering particles 162 and having no irregularities 163 formed on the surfaces thereof.

When the anti-glare layer 16 includes two or more types of particles having different average particle diameters, the difference in average particle diameter between the particles may be 3.5 μm or less, 2.0 μm or less, or 1.5 μm or less. In addition, the difference in average particle diameter may be 0.5 μm or more or 1.0 μm or more. When the difference in average particle diameter is within the above-described range, anti-glare may be improved without causing a deterioration in the SCI of the anti-reflection film 10.

In the disclosure, the average particle diameter may refer to an average primary particle diameter. The average primary particle diameter of the light-scattering particles 162 and the high refractive index nanoparticles 165 may be measured by observing images of a dry film of a particle dispersion liquid, in which the light-scattering particles 162 or the high refractive index nanoparticles 165 are dispersed, through a SEM, a transmission electron microscope (TEM), and a scanning transmission electron microscope (STEM). Because the light-scattering particles 162 have the irregularities 163 on the surfaces thereof, the average primary particle diameter may be measured by approximating the protruding portion among the surface irregularities 163 of the light-scattering particles 162 in the observation image to the outer surface of the light-scattering particles 162. In addition, the average primary particle diameter of the light-scattering particles 162 may also be measured by using a Coulter counter. Furthermore, the average primary particle diameter of the high refractive index nanoparticles 165 may also be measured by a particle size distribution meter using light scattering.

In the disclosure, the nanoparticles may refer to particles having an average primary particle diameter of 100 nm or less.

The surface roughness (Ra) of the irregularities 163 formed on the surfaces of the light-scattering particles 162, i.e., the surface roughness (Ra) of the protruding portion 16b of the anti-glare layer 16, may be greater than the surface roughness (Ra) of the flat portion 16a of the anti-glare layer 16.

When the surface roughness (Ra) of the flat portion 16a is small, the coating property of the low refractive index layer 17 for the flat portion 16a may be improved.

In the disclosure, the surface roughness (Ra) of the flat portion 16a and the surface roughness (Ra) of the protruding portion 16b may be measured by an atomic force microscope (AFM) or the like.

The size of the irregularities 163 formed on the surfaces of the light-scattering particles 162 may be determined by a specific surface area or a silicone oil absorption amount of the light-scattering particles 162. As the shape of the irregularities 163 formed on the surfaces of the light-scattering particles 162 is complicated and the light scattering due to the irregularities 163 increases, the specific surface area or the absorption amount of the light-scattering particles 162 may increase. In an embodiment of the disclosure, the specific surface area of the light-scattering particles 162 may be 5 m²/g or more, 50 m²/g or more, or 80 m²/g or more. An upper limit of the specific surface area of the light-scattering particles 162 is not particularly limited, but in an embodiment of the disclosure, the specific surface area of the light-scattering particles 162 may be 500 m²/g or less. In an embodiment of the disclosure, the silicone oil absorption amount of the light-scattering particles 162 may be about 80 ml/100 g to about 95 ml/100 g. When the light-scattering particles 162 having a specific surface area of less than 5 m²/g or a silicone oil absorption amount of less than 80 ml/100 g are used, a large amount of light-scattering particles 162 has to be mixed with the anti-glare layer 16 so as to ensure anti-glare of the anti-reflection film 10. As a result, the area of the protruding portion 16b in the anti-glare layer 16 may increase, and thus, the coating property of the low refractive index layer 17 for the anti-glare layer 16 may be reduced. The specific surface area of the light-scattering particles 162 may be measured by, for example, a Brunauer-Emmett-Teller (BET) method which measures a specific surface area of a particle from an amount of gas molecules adsorbed onto the particle.

The content of the light-scattering particles 162 may vary depending on the average particle diameter of the light-scattering particles 162, etc. In an embodiment of the disclosure, the content of the light-scattering particles 162 may be about 1 mass % to about 7 mass %, or about 2 mass % to about 5 mass %, based on the total solid content of the anti-glare layer 16. When the content of the light-scattering particles 162 based on the total solid content of the anti-glare layer 16 is less than 1 mass %, the density of the protruding light-scattering particles 162 may decrease, and thus, the area of the protruding portion 16b may be reduced. In this case, the effect of suppressing a phenomenon that light is mirrored on a screen by scattering light due to the protruding portion 16b in the anti-glare layer 16 may be insufficient. When the content of the light-scattering particles 162 is greater than 7 mass %, the area of the protruding portion 16b in the anti-glare layer 16 may increase, and thus, the coating property of the low refractive index layer 17 for the anti-glare layer 16 may deteriorate.

The light-scattering particles 162 may be inorganic particles or organic particles. In an embodiment of the disclosure, the light-scattering particles 162 may be silica particles, alumina particles, titania particles, calcium carbonate particles, PMMA particles, polystyrene particles, polyethylene particles, melamine particles, nylon particles, cellulose acetate particles, silicon particles, or polytetrafluoroethylene (PTFE) particles. In an embodiment of the disclosure, the light-scattering particles 162 may include at least one of silica particles, PMMA particles, melamine particles, calcium carbonate particles, cellulose acetate particles, or silicon particles. In this case, the refractive index and mechanical strength of the resin film may be improved.

The shape of the light-scattering particles 162 is not particularly limited, but in an embodiment of the disclosure, the light-scattering particles 162 may have a spherical shape, an elliptical shape, a needle shape, or an irregular shape.

In an embodiment of the disclosure, the refractive index of the light-scattering particles 162 may be 1.42 or more, and the refractive index of the light-scattering particles 162 may be 1.60 or less.

As described above, the anti-glare layer 16 may include the flat portion 16a having a flat surface shape and the protruding portion 16b where a portion of the light-scattering particles 162 protrudes from the surface of the flat portion 16a. The irregularities 163 caused by the light-scattering particles 162 may be formed in the protruding portion 16b, and the high refractive index nanoparticles 165 may be deposited on the irregularities 163.

Because the high refractive index nanoparticles 165 are arranged in the protruding portion 16b, external light may be scattered and anti-glare may be ensured by the scattering of external light.

To scatter external light, the refractive index of the high refractive index nanoparticles 165 may be 1.60 or more or 1.70 or more. In addition, the refractive index of the high refractive index nanoparticles 165 may be less than 2.50 or less than 2.40.

As long as the refractive index of the high refractive index nanoparticles 165 is within the above-described range, the high refractive index nanoparticles 165 may be inorganic particles or organic particles. In an embodiment of the disclosure, the high refractive index nanoparticles 165 may include one or more selected from alumina, zirconia, and titania. In this case, the high refractive index nanoparticles 165 may have an excellent refractive index. In an embodiment of the disclosure, the high refractive index nanoparticles 165 may include zirconia. In this case, the high refractive index nanoparticles 165 may have a sufficient refractive index and good dispersibility, and may not have catalytic activity or optical activity.

In an embodiment of the disclosure, the high refractive index nanoparticles 165 may have reactive groups on the surfaces thereof by surface treatment. In this case, the high refractive index nanoparticles 165 may improve compatibility with the binder 161 and ensure mechanical strength.

The average particle diameter of the high refractive index nanoparticles 165 may be controlled to a range in which the high refractive index nanoparticles 165 may be deposited on the irregularities 163 of the protruding portion 16b due to the light-scattering particles 162. In particular, at least a portion of the high refractive index nanoparticles 165 may be buried between the irregularities 163 and may not be separated from the irregularities 163. Therefore, the average particle diameter of the high refractive index nanoparticles 165 may vary depending on the size of the irregularities 163 of the light-scattering particles 162. In an embodiment of the disclosure, the average particle diameter of the high refractive index nanoparticles 165 may be about 5 nm to about 100 nm. When the average particle diameter of the high refractive index nanoparticles 165 is less than 5 nm, the effect that the high refractive index nanoparticles 165 scatter external light may be insignificant. When the average particle diameter of the high refractive index nanoparticles 165 is greater than 100 nm, the haze may excessively increase, resulting in an increase in reflectance.

The content of the high refractive index nanoparticles 165 may vary depending on the content of the light-scattering particles 162, the average particle diameter of the high refractive index nanoparticles 165, the size of the irregularities 163, etc. In an embodiment of the disclosure, the content of the high refractive index nanoparticles 165 may be about 5.0 mass % to about 40 mass %, or about 10 mass % to about 35 mass %, based on the total solid content of the anti-glare layer 16. When the content of the high refractive index nanoparticles 165 is less than 5.0 mass %, the amount of the high refractive index nanoparticles 165 may be small, and thus, the amount of the high refractive index nanoparticles 165 deposited on the irregularities 163 of the light-scattering particles 162 may be reduced. In this case, anti-glare due to the high refractive index nanoparticles 165 in the anti-glare layer 16 may be insufficient. When the content of the high refractive index nanoparticles 165 is greater than 40 mass %, the amount of the high refractive index nanoparticles 165 deposited on the irregularities 163 of the light-scattering particles 162 may become excessive, resulting in an increase in reflectance.

As described below, when the anti-glare layer 16 is formed, the high refractive index nanoparticles 165 may be mixed as solids of a coating solution for the anti-glare layer 16 together with the light-scattering particles 162 having the irregularities 163. After the coating solution is applied, the anti-glare layer 16 may be formed by drying and photopolymerization. In this case, the high refractive index nanoparticles 165 are deposited on the irregularities 163 of the light-scattering particles 162 in the anti-glare layer 16, but may also remain in the binder 161. That is, the anti-glare layer 16 may further include high refractive index nanoparticles 165 that are not deposited on the irregularities 163. Because the high refractive index nanoparticles 165 deposited on the light-scattering particles 162 mainly contribute to the reflectance reduction effect and anti-glare effect of the high refractive index nanoparticles 165, the amount of the high refractive index nanoparticles 165 mixed with the coating solution may be adjusted so as to ensure a desired deposition amount.

The difference in refractive index between the binder 161 and the light-scattering particles 162 included in the anti-glare layer 16 may be small. In an embodiment of the disclosure, the difference in refractive index between the binder 161 and the light-scattering particles 162 may be 0.20 or less or 0.15 or less. In this case, because the difference in refractive index between the binder 161 and the light-scattering particles 162 is small, light scattering at the interface between the binder 161 and the light-scattering particles 162 may be reduced. Therefore, it is possible to suppress an increase in the inner haze of the anti-glare layer 16 and to reduce the SCI of the anti-reflection film 10.

In addition, the interface (X in FIG. 3) between the binder 161 and the light-scattering particles 162 in the anti-glare layer 16 may be compatible. In this case, because the refractive index at the interface between the binder 161 and the light-scattering particles 162 changes continuously, backscattering at the interface may be reduced and inner haze may be lowered.

In a portion where the interface between the binder 161 and the light-scattering particles 162 is compatible, the size of the irregularities 163 formed on the surfaces of the light-scattering particles 162 may be reduced. However, the irregularities 163 of the light-scattering particles 162 protruding from the surface of the binder 161 may be maintained. Accordingly, even when the interface between the binder 161 and the light-scattering particles 162 in the anti-glare layer 16 is compatible, the effect that light is scattered by the irregularities 163 of the light-scattering particles 162 may be maintained.

In an embodiment of the disclosure, a compatibilizer may be mixed to compatibilize the interface between the binder 161 and the light-scattering particles 162. As described below, in an embodiment of the disclosure, when the coating solution for manufacturing the anti-glare layer 16 is applied (coated), a solvent that dissolves a component included in the light-scattering particles 162 may be mixed. By observing the cross-section of the anti-glare layer 16 through a SEM or the like, it may be confirmed that the interface between the binder 161 and the light-scattering particles 162 is compatibilized.

As a method of improving anti-glare due to the anti-glare layer 16, there may be a method of increasing the frequency of irregularities on the surface of the anti-glare layer 16 so as to increase an outer haze value. However, when the frequency of irregularities on the surface of the anti-glare layer 16 is increased, the area of the flat region where the low refractive index layer 17 or the like is uniformly coated may be reduced, and thus, the coating property of the low refractive index layer 17 or the like formed on the anti-glare layer 16 may deteriorate. In this case, the amount of light reflection at the interface between the anti-glare layer 16 and the low refractive index layer 17 may not be sufficiently reduced. Accordingly, the image displayed on the liquid crystal panel (see 1a of FIG. 1B) may become white and blurred, and the sharpness of the image may deteriorate.

When coating is performed by sputtering or deposition, the low refractive index layer 17 may be uniformly formed even on the anti-glare layer 16 with a large surface roughness. However, because the low refractive index layer 17 formed in the above-described method has a high refractive index, stacking (e.g., 4 layers) with the high refractive index layer may be required to ensure sufficient anti-reflection characteristics. As a result, coloration may appear when the anti-reflection film 10 is observed at an oblique angle. In addition, manufacturing costs may also increase significantly.

However, when the anti-glare layer 16 according to an embodiment of the disclosure has the configuration described above, excellent anti-glare may be ensured and reflectance of the anti-reflection film 10 may be reduced.

That is, a portion of the light-scattering particles 162 may protrude to form a plurality of protruding portions 16b in the anti-glare layer 16. The irregularities 163 caused by the light-scattering particles 162 may be formed on the surfaces of the protruding portions 16b. The surface roughness (Ra) of the protruding portion 16b may be greater than the surface roughness (Ra) of the flat portion 16a. Accordingly, compared to a case in which the irregularities 163 are not formed in the surface of the protruding portion 16b, the outer haze value of the anti-glare layer 16 may increase, and thus, external light may be more easily scattered on the surface of the anti-glare layer 16. In addition, external light may be more easily scattered by the high refractive index nanoparticles 165 deposited on the irregularities 163. As a result, external light may be suppressed from being mirrored on the liquid crystal panel (see 1a of FIG. 1B) and anti-glare of the anti-reflection film 10 may be significantly improved.

In addition, the flat portion 16a having a large area may be formed in the anti-glare layer 16. Due to this, the low refractive index layer 17 may be uniformly formed on the flat portion 16a of the anti-glare layer 16, and thus, a decrease in the coating property of the low refractive index layer 17 may be suppressed. That is, even when the low refractive index layer 17 is formed by wet coating, the low refractive index layer 17 may be uniformly formed on the anti-glare layer 16. As a result, the reflectance of the liquid crystal panel (see 1a of FIG. 1B) may be reduced by the low refractive index layer 17, and the sharpness of the image displayed on the liquid crystal panel (see 1a of FIG. 1B) may be improved.

A gloss value of the anti-glare layer 16 may be 10 or less or 5 or less, as measured from the low refractive index layer 17 side when light is incident on the surface of the anti-glare layer 16 at an incident angle of 20°.

In addition, a gloss value of the anti-glare layer 16 may be 45 or less or 35 or less, as measured from the low refractive index layer 17 side when light is incident on the surface of the anti-glare layer 16 at an incident angle of 60°.

As the gloss value of the anti-glare layer 16 decreases, light may be easily scattered on the surface of the anti-glare layer 16, and light may be suppressed from being mirrored on the liquid crystal panel (see 1a of FIG. 1B). In the disclosure, the expression “measured from the low refractive index layer 17 side” may mean that the gloss value of only the anti-glare layer 16 is measured when light is incident from the side on which the low refractive index layer 17 is to be stacked, that is, from a direction in which the light-scattering particles 162 protrude to form the protruding portion 16b.

When the anti-glare layer 16 is viewed from the direction in which the low refractive index layer 17 is to be stacked (e.g., from above in FIG. 2), a ratio of the area of the flat portion 16a to the area of the protruding portion 16b of the anti-glare layer 16 ((the area of the flat portion 16a)/(the area of the protruding portion 16b)) may be about 2.0 to about 30, or about 5.0 to about 20.

When the ratio of the area of the flat portion 16a to the area of the protruding portion 16b is less than 2.0, the area of the flat portion of the anti-glare layer 16 may be reduced, and thus, the coating property of the low refractive index layer 17 may deteriorate. When the ratio of the area of the flat portion 16a to the area of the protruding portion 16b is greater than 30, the area of the protruding portion 16b may be reduced, and thus, it may become difficult to scatter light due to the irregularities 163 formed on the surface of the protruding portion 16b.

The thickness of the anti-glare layer 16 at the flat portion 16a may be about 0.5 μm to about 10 μm, or about 1 μm to about 6 μm. When the thickness of the anti-glare layer 16 at the flat portion 16a is less than 0.5 μm, the ability of the binder 161 constituting the flat portion 16a to fix the light-scattering particles 162 may be reduced. In addition, mechanical properties required for the anti-glare layer 16, such as pencil hardness, may be insufficient. When the thickness of the anti-glare layer 16 at the flat portion 16a is greater than 10 μm, it may become difficult for the light-scattering particles 162 to protrude from the surface of the flat portion 16a, making it difficult for the protruding portion 16b to be formed. In this case, the effect of suppressing a phenomenon that light is mirrored on a screen by scattering light due to the protruding portion 16b in the anti-glare layer 16 may be insufficient.

In addition, the height at which the light-scattering particles 162 protrude from the surface of the flat portion 16a in the protruding portion 16b may be about 20% to about 80%, or about 30% to about 70%, of the particle diameter of the light-scattering particles 162.

As the anti-glare layer 16 according to an embodiment of the disclosure, a case in which the low refractive index layer 17 is not stacked on the surface of the protruding portion 16b and the irregularities 163 of the surfaces of the light-scattering particles 162 are exposed has been described, but embodiments of the disclosure are not limited thereto. When a portion where the high refractive index nanoparticles 165 are deposited on the irregularities163 is exposed to a desired extent, there may be a portion where the irregularities 163 of the surfaces of the light-scattering particles 162 are covered by the low refractive index layer 17.

In addition, the anti-glare layer 16 may also include particles having a small average particle diameter. The particles having a small average particle diameter may refer to particles having a smaller average particle diameter than the thickness of the binder 161 included in the anti-glare layer 16 (i.e., the thickness of the anti-glare layer 16 at the flat portion 16a). Hereinafter, for convenience of explanation, these particles are referred to as fine particles. The fine particles may include polymethyl (meth)acrylate, styrene, polyacrylic-styrene copolymer, melamine resin, silicone, fluororesin, silica, alumina, etc. In an embodiment of the disclosure, by mixing fine particles with the anti-glare layer 16, the uniform anti-glare layer 16 in which excessive agglomeration of the light-scattering particles 162 is suppressed may be formed.

When the thickness of the anti-glare layer 16 at the flat portion 16a is T, the average particle diameter of the fine particles may be about 0.1 T to about 0.9 T, about 0.2 T to about 0.8 T, or about 0.3 T to about 0.7 T. In an embodiment of the disclosure, the average particle diameter of the fine particles may be about 0.5 μm to about 3.0 μm, or about 0.8 μm to 2.3 μm. When the average particle diameter of the fine particles is less than the above-described range, backscattering of incident light to the anti-glare layer 16 may increase, resulting in an increase in reflectance. When the average particle diameter of the fine particles is greater than the above-described range, the fine particles may protrude from the surface of the binder 161, making it difficult to uniformly coat the low refractive index layer 17. In this case, the low refractive index layer 17 may make it difficult to lower the reflectance of the liquid crystal panel (see 1a of FIG. 1B).

In an embodiment of the disclosure, the anti-glare layer 16 may further include nanoparticles. The nanoparticles may refer to particles having an average particle diameter of 100 nm or less. In the disclosure, the nanoparticles may refer to particles having an average particle diameter of 100 nm or less, excluding the high refractive index nanoparticles 165 included in the anti-glare layer 16. The nanoparticles may include silica or the like. According to an embodiment of the disclosure, because the binder 161 of the anti-glare layer 16 includes the nanoparticles, the specific gravity and viscosity of the binder 161 may increase, which prevents the light-scattering particles 162 in the anti-glare layer 16 from agglomerating with each other.

The content of the nanoparticles may be about 1 mass % to about 40 mass %, or about 3 mass % to about 30 mass %, based on the total solid content of the anti-glare layer 16. When the content of the nanoparticles is within the above-described range, the nanoparticles in the anti-glare layer 16 may be prevented from agglomerating with each other, and the above-described effect due to the nanoparticles may be obtained.

### Low Refractive Index Layer

The low refractive index layer 17 may be a layer for reducing the reflectance of the liquid crystal panel (see 1a of FIG. 1B). In an embodiment of the disclosure, the low refractive index layer 17 may be provided on the flat portion 16a of the anti-glare layer 16.

The low refractive index layer 17 may be a layer having a relatively low refractive index. In an embodiment of the disclosure, the refractive index of the low refractive index layer 17 may be less than 1.40, or about 1.20 to about 1.34. When the refractive index of the low refractive index layer 17 is within the above-described range, the reflectance of the liquid crystal panel (see 1a of FIG. 1B) may be further reduced.

The low refractive index layer 17 may have a single-layer or multilayer structure. As the number of layers of the low refractive index layer 17 decreases, the manufacturing costs may be reduced.

The thickness of the low refractive index layer 17 may be about 50 nm to about 500, about 80 nm to about 120 nm, or about 90 nm to about 110 nm.

In an embodiment of the disclosure, the low refractive index layer 17 may include a binder 171 and hollow particles 172 distributed in the binder 171. In an embodiment of the disclosure, the hollow particles 172 may be hollow silica particles. In addition, the low refractive index layer 17 may further include a surface modifier that is mainly distributed on the surface side (e.g., the upper side in FIG. 2) of the binder 171.

In an embodiment of the disclosure, the binder 171 may include a three-dimensional crosslinking structure and may link the hollow silica particles 172 to each other. The binder 171 may include a resin as a main component.

In an embodiment of the disclosure, the resin may include a fluorine-containing resin. In this case, the entire resin may include fluorine-containing resin, or a portion of the resin may include fluorine-containing resin. The fluorine-containing resin, which is a resin including fluorine, may include PTFE, perfluoroalkoxyalkane (PFA), perfluoroethylenepropene copolymer (FEP), or ethylenetetrafluoroethylene copolymer (ETFE). The fluorine-containing resin may have a low refractive index. Therefore, because the binder 171 includes the fluorine-containing resin, the refractive index of the low refractive index layer 17 may be further lowered, and the reflectance may be further reduced.

In an embodiment of the disclosure, the fluorine-containing resin may be photocurable fluorine-containing resin. The photocurable fluorine-containing resin may be a photopolymerization product of a photocurable fluorine-containing monomer represented by Formulae 1 and 2 below.

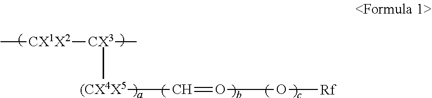

(wherein X¹ and X² are each H or F, X³ is H, F, CH³, or CF³, and X⁴ and X⁵ are each H, F, or CF³. Rf is an organic group in which one to three Y¹(s) are bonded to a C₁-C₄₀ fluorine-containing alkyl group or a C₂-C₁₀₀ fluorine-containing alkyl group having an ether bond. Y¹ is a C₂-C₁₀ monovalent organic group having an ethylenic carbon-carbon double bond at a terminal. a is 0, 1, 2, or 3, and b and c are each 0 or 1.)

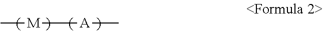

(wherein a structural unit M is a structural unit derived from a fluorine-containing ethylenic monomer represented by Formula 1 above. A structural unit A is a structural unit derived from a monomer copolymerizable with a fluorine-containing ethylenic monomer represented by Formula 1 above.)

The photocurable fluorine-containing resin may include about 0.1 mol % to about 100 mol % of the structural unit M, and may include more than 0 mol % and 99.9 mol % or less of the structural unit A. In addition, the number average molecular weight of the photocurable fluorine-containing resin may be about 30,000 to about 1,000,000.

In an embodiment of the disclosure, the photocurable fluorine-containing resin may be OPTOOL AR-110 manufactured by Daikin Industries, Ltd., EBECRYL8110 manufactured by Daicel Allnex Co., Ltd., or LINC series manufactured by Kyoeisha Chemical Co., Ltd.

In addition, in an embodiment of the disclosure, the binder that does not include a fluorine atom may be light acrylate POB-A, NP-A, DCP-A, TMP-A, UA-3061, or UA-306H manufactured by Kyoeisha Chemical Co., Ltd., NK ester A-DOD-N, A-200, or A-BPE-4 manufactured by Shin-Nakamura Chemical Industry Co., Ltd., Aronix M-315, M-306, or M-408 manufactured by Dong-A Synthetic Co., Ltd., Aronix M-315, M-306, or M-408 manufactured by Dong-A Synthetic Co., Ltd., etc. The binder may improve strength of the film.

The hollow silica particles 172 may have an outer layer, and the interior of the outer layer may be a hollow or porous body. In an embodiment of the disclosure, the outer layer and the porous body may each include silicon dioxide (SiO₂). In addition, a plurality of photopolymerizable groups and hydroxyl groups may be bonded to the surface side of the outer layer. The photopolymerizable group and the outer layer may be bonded to each other through at least one of a Si—O—Si bond or a hydrogen bond. In an embodiment of the disclosure, the photopolymerizable group may be an acryloyl group or a methacryloyl group. That is, the hollow silica particles 172 may include at least one of an acryloyl group or a methacryloyl group as the photopolymerizable group. The photopolymerizable group may be referred to as an ionizing radiation curing group. The hollow silica particles 172 may have a photopolymerizable group, and the number and type of such functional groups are not particularly limited.

In an embodiment of the disclosure, the average primary particle diameter of the hollow silica particles 172 may be about 35 nm to about 120, or about 40 nm to about 110 nm. When the average primary particle diameter of the hollow silica particles 172 is less than 35 nm, the porosity of the hollow silica particles 172 may decrease and the effect of lowering the refractive index of the low refractive index layer 17 may be insignificant. In addition, when the average primary particle diameter of the hollow silica particles 172 is greater than 120 nm, the surface roughness of the low refractive index layer 17 may increase. Therefore, the antifouling and scratch resistance of the low refractive index layer 17 may be reduced.

The average primary particle diameter of the hollow silica particles 172 may be measured by observing an image of a dry film of a particle dispersion liquid, in which the hollow silica particles 172 are dispersed, through a SEM, a TEM, and an STEM.

The content of the hollow silica particles 172 may be about 30 mass % to about 65 mass % in the low refractive index layer 17. When the content of the hollow silica particles 172 is less than 30 mass %, the refractive index of the low refractive index layer 17 may increase, and thus, the reflectance of the anti-reflection film 10 may increase. When the content of the hollow silica particles 172 is greater than 65 mass %, the strength of the film may be reduced and attachments may become more noticeable and difficult to remove.

A frequency curve (a particle size distribution curve) of the hollow silica particles 172 with respect to the particle diameter may have a plurality of peaks. In this case, the hollow silica particles 172 may include a plurality of particles having different particle diameter distributions. In an embodiment of the disclosure, the hollow silica particles 172 may include a mixture of a plurality of particles selected from among particles having a primary particle diameter of about 30 nm, about 60 nm, and about 75 nm.

The surface modifier may be mainly distributed on the surface side of the binder 171 and may modify the surface of the low refractive index layer 17. That is, the surface modifier may be segregated on the surface side of the low refractive index layer 17. Even when the surface modifier exists inside the binder 171, the function of the low refractive index layer 17 may not be affected.

In an embodiment of the disclosure, the surface modifier may include an oil-repellent surface modifier and a lipophilic surface modifier.

The oil-repellent surface modifier may be mixed with the binder 171 and segregated on the surface to improve the oil-repellent property of the surface of the film. The effect of the oil-repellent surface modifier may be confirmed by measuring a contact angle of oleic acid, etc. In this case, the effect may be confirmed by the difference between the contact angle on the surface of the film (the low refractive index layer 17) when the oil-repellent surface modifier is mixed and the contact angle on the surface of the film (the low refractive index layer 17) when the oil-repellent surface modifier is not mixed, that is, (the contact angle when mixed)−(the contact angle when not mixed). The contact angle may increase when the oil-repellent surface modifier is mixed with the binder 171. In an embodiment of the disclosure, the difference in contact angle may be 10° or more, 20° or more, or 30° or more.

In an embodiment of the disclosure, the oil-repellent surface modifier may be a fluorine-based compound having a photopolymerizable group.

In an embodiment of the disclosure, the oil-repellent surface modifier may be KY-1203 or KY-1207 manufactured by Shin-Etsu Chemical Co., Ltd., Optool DAC-HP manufactured by Daikin Industries, Ltd., Megapak F-477, F-554, F-556, F-570, RS-56, RS-58, RS-75, RS-78, or RS-90 manufactured by DIC Corporation, FS-7024, FS-7025, FS-7026, FS-7031, or FS-7032 manufactured by Fluorotechnology Co., Ltd., H-3593, or H-3594 manufactured by Daiichi Kogyo Pharmaceutical Co., Ltd., SURECO AF Series manufactured by AGC Corporation, and Ftergent F-222F, M-250, 601AD, or 601ADH2 manufactured by Neos Corporation.

The lipophilic surface modifier may be mixed with the binder 171 and segregated on the surface to improve the lipophilic property of the surface of the film. The effect of the lipophilic surface modifier may be confirmed by measuring a contact angle of oleic acid, etc. In this case, the effect may be confirmed by the difference between the contact angle on the surface of the film (the low refractive index layer 17) when the lipophilic surface modifier is mixed and the contact angle on the surface of the film (the low refractive index layer 17) when the lipophilic surface modifier is not mixed ((the contact angle when mixed)−(the contact angle when not mixed)). The contact angle may decrease when the lipophilic surface modifier is mixed with the binder 171. In an embodiment of the disclosure, the difference in contact angle may be 3° or more, 5° or more, or 7° or more.

In an embodiment of the disclosure, the lipophilic surface modifier may be Melclear 350L manufactured by Sanyo Chemical Industries, Ltd., or Ftergent 730 LM, 602A, 650A, or 650AC manufactured by Neos Corporation.

Even when attachments such as sebum are bonded to the low refractive index layer 17, the attachments may not be noticeable. In addition, the attachments may be easily wiped off. These effects may be equally observed even when a large amount of hollow silica particles 172 are included.

### High Refractive Index Layer

The structure of the anti-reflection film 10 is not limited to the structure illustrated in FIG. 2. An anti-reflection film 10 according to an embodiment of the disclosure may further include a high refractive index layer.

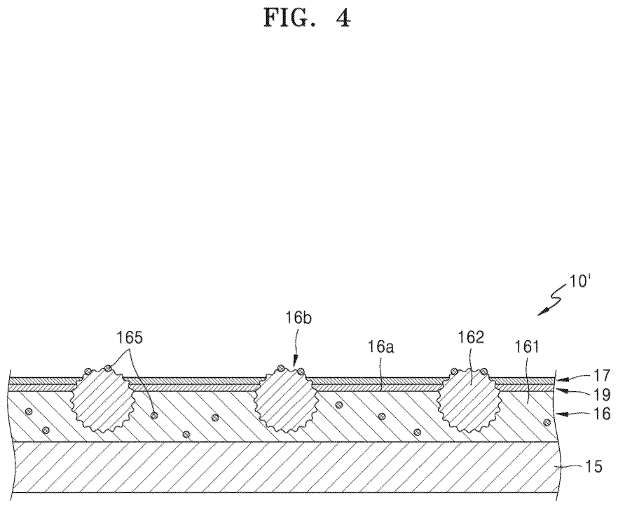

FIG. 4 is a cross-sectional view schematically illustrating the anti-reflection film 10′ according to an embodiment of the disclosure. In FIG. 4, the same components as in FIG. 2 are denoted by the same reference numerals, and a redundant description thereof is omitted.

Referring to FIG. 4, the anti-reflection film 10′ according to an embodiment of the disclosure may include a substrate 15, an anti-glare layer 16, a high refractive index layer 19, and a low refractive index layer 17, which are sequentially stacked in this stated order. That is, the anti-reflection film 10′ illustrated in FIG. 4 differs from the anti-reflection film 10 illustrated in FIG. 2 in that the anti-reflection film 10′ illustrated in FIG. 4 includes the high refractive index layer 19.

The high refractive index layer 19 may be a layer having a relatively high refractive index. The high refractive index layer 19 may further reduce the reflectance of the liquid crystal panel (see 1a of FIG. 1B). By stacking the high refractive index layer 19 and the low refractive index layer 17, the reflectance may be further reduced by the interference effect of light. In addition, the reflection chromaticity may be reduced because the reflectance may be lowered in a broad wavelength range.

The high refractive index layer 19 may be provided below the low refractive index layer 17, that is, between the anti-glare layer 16 and the low refractive index layer 17. That is, it may be said that the high refractive index layer 19 is provided between a flat portion 16a of the anti-glare layer 16 and the low refractive index layer 17.

The high refractive index layer 19 may include a binder and high refractive index particles. Therefore, the high refractive index layer 19 may be formed by using a coating solution including the binder and the high refractive index particles. The high refractive index layer 19 may have a single-layer or multilayer structure. As the number of layers of the high refractive index layer 19 decreases, the manufacturing costs may be reduced.

The refractive index of the high refractive index layer 19 may be high. In this case, the reflectance of the liquid crystal panel (see 1a of FIG. 1B) may be further reduced. In an embodiment of the disclosure, the refractive index of the high refractive index layer 19 may be about 1.65 to about 1.80, or about 1.67 to about 1.75.

In an embodiment of the disclosure, the thickness of the high refractive index layer 19 may be 500 nm or less, 350 nm or less, 200 nm or less, or 170 nm or less. In an embodiment of the disclosure, the thickness of the high refractive index layer 19 may be 50 nm or more, 80 nm or more, 100 nm or more, or 130 nm or more.

In an embodiment of the disclosure, the high refractive index particles may include zirconium oxide, hafnium oxide, tantalum oxide, titanium oxide, zinc oxide, aluminum oxide, magnesium oxide, tin oxide, yttrium oxide, barium titanate, antimony-doped tin oxide (ATO), phosphorus-doped tin oxide (PTO), indium-doped tin oxide (ITO), zinc sulfide, or the like. In terms of durability and stability, the high refractive index particles may include zirconium oxide, barium titanate, ATO, PTO, or ITO.

The high refractive index particles may have similar properties to the high refractive index nanoparticles 165 included in the anti-glare layer 16. Because the high refractive index particles have similar properties to high refractive index nanoparticles 165, the coating uniformity of the high refractive index layer 19 may be improved and the reflectance may be reduced. In an embodiment of the disclosure, the high refractive index particles may include one or more selected from alumina, zirconia, and titania. The above-described effect may be achieved by using particles having similar properties, such as a combination of alumina and zirconia or a combination of zirconia and titania. In an embodiment of the disclosure, the high refractive index particles and the high refractive index nanoparticles 165 may include the same material.

In an embodiment of the disclosure, the average particle diameter of primary particles (the average primary particle diameter) of the high refractive index particles may be about 1 nm to about 200 nm, about 3 nm to about 100 nm, or about 5 nm to about 50 nm. The average primary particle diameter of the high refractive index particles may be measured by observing an image of a dry film of a particle dispersion liquid, in which the high refractive index particles are dispersed, through a SEM, a TEM, and an STEM.

Furthermore, the average primary particle diameter of the high refractive index particles may also be measured by using a particle size distribution meter using light scattering.

A dispersion stabilization treatment may be performed on the high refractive index particles so as to suppress agglomeration. In an embodiment of the disclosure, the dispersion stabilization treatment may be performed by using a method of using surface-treated particles, a method of adding a dispersant, or a method of adding other particles having a lower surface charge than high refractive index particles.

In an embodiment of the disclosure, the content of the high refractive index particles may be about 20 parts by mass to about 500 parts by mass, about 50 parts by mass to about 400 parts by mass, or about 100 parts by mass to about 300 parts by mass, based on 100 parts by mass of the binder.

In this case, to reduce the content of the high refractive index particles, the refractive index of the binder may be about 1.45 to about 1.70.

The high refractive index layer 19 may include, in addition to the binder and the high refractive index particles, other components as necessary. For example, the high refractive index layer 19 may further include a dilution solvent and an additive, such as a polymerization initiator, a UV absorber, a leveling agent, or a surfactant. In an embodiment of the disclosure, because the high refractive index layer 19 further includes the leveling agent or the surfactant, the surface state of the high refractive index layer 19 may be controlled, and therefore, the performance of the upper layer (e.g., the low refractive index layer 17) may be improved.

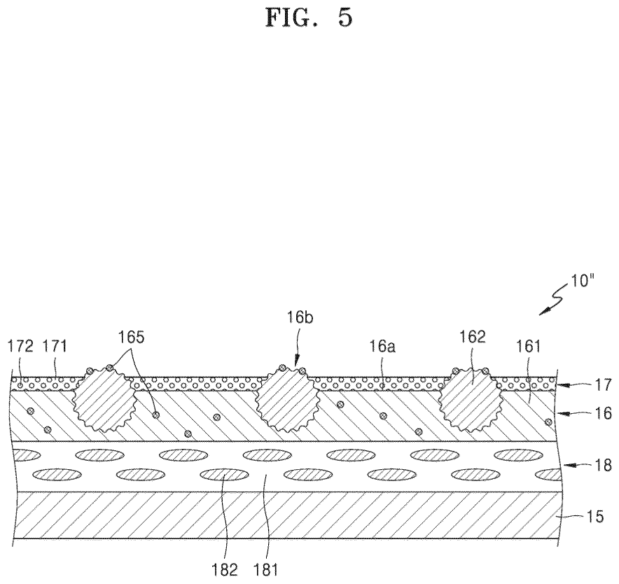

The high refractive index layer 19 may be applied to an anti-reflection film 10″ having an anisotropic diffusion layer (see 18 of FIG. 5) to be described below. That is, the anti-reflection film 10″ having the anisotropic diffusion layer (see 18 of FIG. 5) may further include the high refractive index layer 19 between the anti-glare layer 16 and the low refractive index layer 17, as illustrated in FIG. 4.

### Anti-Reflection Film

Hereinafter, characteristics of the anti-reflection film 10 or 10′ including the anti-glare layer 16 and the low refractive index layer 17 are described.

In an embodiment of the disclosure, the total haze value, which is the sum of the inner haze value and the outer haze value of the anti-reflection film 10, may be 5% or more or 10% or more. In an embodiment of the disclosure, the total haze value of the anti-reflection film 10 or 10′ may be 80% or less or 60% or less. In the disclosure, the haze value of the anti-reflection film 10 or 10′ may be measured in accordance with JIS K7136:2000. When the total haze value of the anti-reflection film 10 is less than 5%, anti-glare of the anti-reflection film 10 or 10′ may be insufficient, and thus, a phenomenon in which light is mirrored on the liquid crystal panel (see 1a of FIG. 1B) may occur.

The outer haze value of the anti-reflection film 10 or 10′ may be 3% % or more or 7% or more. The outer haze value of the anti-reflection film 10 may be associated with the surface shape of the anti-reflection film 10. As the outer haze value of the anti-reflection film 10 or 10′ increases, light may be better scattered on the surface of the anti-reflection film 10 or 10′. In an embodiment of the disclosure, the outer haze value of the anti-reflection film 10 or 10′ may be associated with the protruding portion 16b of the anti-glare layer 16 and the irregularities 163 formed on the surface of the protruding portion 16b (or the surfaces of the light-scattering particles 162).

When the outer haze value of the anti-reflection film 10 is 3% or more, anti-glare of the anti-reflection film 10 or 10′ may be further improved by suppressing light from being mirrored on the liquid crystal panel (see 1a of FIG. 1B).

The outer haze value of the anti-reflection film 10 or 10′ may be obtained by subtracting, from the total haze value, the inner haze value measured by a method described below.

The inner haze value of the anti-reflection film 10 or 10′ may be 5% or less or 2.5% or less. The inner haze value of the anti-reflection film 10 or 10′ may be associated with a composition of each layer constituting the anti-reflection film 10 or 10′. As the inner haze value of the anti-reflection film 10 or 10′ decreases, it becomes more difficult for light to be scattered within the anti-reflection film 10 or 10′.

When the inner haze value of the anti-reflection film 10 is 5% or less, a deterioration in sharpness of an image displayed on the liquid crystal panel (see 1a of FIG. 1B) may be suppressed due to scattering of light within the anti-reflection film 10.

The inner haze value of the anti-reflection film 10 or 10′ may be measured in accordance with JIS K7136:2000 while the irregularities of the protruding portion 16b is made flat by filling the irregularities of the protruding portion 16b exposed on the surface of the anti-reflection film 10 or 10′ with a liquid having a refractive index substantially equal to a refractive index of the anti-glare layer 16 without dissolving the anti-glare layer 16 (in particular, the light-scattering particles 162).

In an embodiment of the disclosure, the gloss value of the anti-reflection film 10 or 10′ may be 4 or less or 2 or less, as measured from the low refractive index layer 17 side when light is incident on the surface of the anti-reflection film 10 at an incident angle of 20°.

In addition, the gloss value of the anti-reflection film 10 or 10′ may be 20 or less or 10 or less, as measured from the low refractive index layer 17 side when light is incident on the surface of the anti-reflection film 10 or 10′ at an incident angle of 60°.

When the gloss value of the anti-reflection film 10 or 10′ is low, light may be well scattered on the surface of the anti-reflection film 10 or 10′, and thus, light may be suppressed from being mirrored on the liquid crystal panel (see 1a of FIG. 1B).

FIG. 5 is a cross-sectional view schematically illustrating an anti-reflection film 10″ according to an embodiment of the disclosure. The structure of the anti-reflection film 10″ is not limited to the structure illustrated in FIG. 2. Referring to FIG. 5, the anti-reflection film 10″ according to an embodiment of the disclosure may include an anisotropic diffusion layer 18 that is arranged between a resin film and a substrate 15 and anisotropically diffuses light.

In FIG. 5, the same components as in FIG. 2 are denoted by the same reference numerals, and a redundant description thereof is omitted.

Referring to FIG. 5, the anti-reflection film 10″ according to an embodiment of the disclosure may include the substrate 15, the anisotropic diffusion layer 18, an anti-glare layer 16, and a low refractive index layer 17, which are sequentially stacked in this stated order. That is, the anti-reflection film 10″ illustrated in FIG. 5 differs from the anti-reflection film 10 illustrated in FIG. 2 in that the anisotropic diffusion layer 18 is included in the anti-reflection film.

The anisotropic diffusion layer 18 may anisotropically diffuse incident light. The expression “anisotropically diffuse” may mean having strong light diffusion in a particular direction. Therefore, the anisotropic diffusion layer 18 may have strong light diffusion in a particular direction. Therefore, when isotropic light (circular light) such as laser light is radiated onto a member including the anisotropic diffusion layer 18, the transmitted light may be linear or elliptical.

The anisotropic diffusion layer 18 may include a resin portion 181 and anisotropic particles 182.

The resin portion 181 may include a resin that disperses the anisotropic particles 182. The resin portion 181 may also be referred to as a dispersion layer that fixes the long axis direction of the anisotropic particles 182 so as to be arranged along one direction.

The anisotropic particles 182 may have an anisotropic shape. The anisotropic particles 182 may be arranged within the resin portion 181 so that the long axis direction thereof follows one direction. FIG. 5 illustrates that the longitudinal direction of the anisotropic particles 182 according to an embodiment of the disclosure is arranged along an in-plane direction of the anisotropic diffusion layer 18.

As described above, the resin portion 181 may include the resin. In an embodiment of the disclosure, the refractive index of the resin portion 181 may be about 1.45 to about 1.65. The SCE, which is the reflectance excluding the SCI of the diffusion layer 18, may be 1.0% or less. When the refractive index of the resin portion 181 is within the above-described range, the SCE of the anisotropic diffusion layer 18 may have the above-described numerical range. When the refractive index of the resin portion 181 is outside the above-described range, the SCE of the anisotropic diffusion layer 18 may be greater than 1.0%.

The resin included in the resin portion 181 may be (meth)acrylic resin, polyethylene resin, polypropylene resin, polystyrene resin, polyurethane resin, polycarbonate resin, polyester resin, or silicone resin.

As described above, the anisotropic particles 182 may have an anisotropic shape. In an embodiment of the disclosure, the anisotropic particles 182 may have an elliptical spherical shape. Because the anisotropic particles 182 have the above-described shape, the refractive index in the long axis direction may be different from the refractive index in the short axis direction. Due to this, anisotropic diffusion may occur in the anisotropic diffusion layer 18. In addition, the refractive index of the anisotropic particles 182 may be different from the refractive index of the resin portion 181. The shape of the anisotropic particles 182 is not particularly limited as long as the anisotropic particles 182 have an anisotropic shape. In an embodiment of the disclosure, the anisotropic particles 182 may have a spindle shape, a needle shape, a fibrous shape, a cylindrical shape, or a disc shape.

In an embodiment of the disclosure, the interface between the anisotropic particles 182 and the resin portion 181 may be compatible. In this case, the refractive index at the interface between the anisotropic particles 182 and the resin portion 181 may change continuously, and thus, backscattering at the interface may be reduced and the SCE of the anisotropic diffusion layer 18 may be lowered. The boundary between the anisotropic particles 182 and the resin portion 181 may not be clear because the boundary is compatible, but the anisotropic particles 182 may clearly exist as particles within the resin portion 181. To compatibilize the interface between the anisotropic particles 182 and the resin portion 181, a compatibilizer may be mixed, or a solvent that dissolves the surface layers of the anisotropic particles 182 may be used as a coating solvent. The compatibilization of the interface between the anisotropic particles 182 and the resin portion 181 may be confirmed by observing the cross-section of the anisotropic diffusion layer 18 through a SEM, etc.

In an embodiment of the disclosure, the anisotropic particles 182 may include at least one of a metal oxide, a carbonate compound, a hydroxide compound, or a phosphate compound. In this case, the metal oxide may be silica, titanium oxide, aluminum oxide, or zinc oxide. In an embodiment of the disclosure, the anisotropic particles 182 may be a compound, such as calcium carbonate, silicon carbide, nitrogen carbide, or basic magnesium sulfate, glass fiber, (meth)acrylic resin, polystyrene resin, or melamine resin.

In an embodiment of the disclosure, the haze value of the anisotropic diffusion layer 18 may be about 20% to about 80%, or about 30% to about 65%. When the haze value of the anisotropic diffusion layer 18 is within the above-described numerical range, a clear image quality may be ensured when the anisotropic diffusion layer 18 is mounted on a display.

The anisotropic diffusion property of the anisotropic diffusion layer 18 may be measured through a goniophotometer. When light is radiated onto the anisotropic diffusion layer 18 at an incident angle of 0° (e.g., in a direction perpendicular to the anisotropic diffusion layer 18), the transmitted light may be obtained while changing an acceptance angle. In this manner, the intensity distribution of the transmitted scattered light may be measured. The anisotropic diffusion property may be quantitatively evaluated by obtaining the amount of transmitted light of the transmitted scattered light in an anisotropic diffusion direction and a direction perpendicular to the anisotropic diffusion direction. In the disclosure, the anisotropic diffusion property may be evaluated by an anisotropy diffusion value (ADV). The ADV may be calculated by Equation 1 below.

$$ADV = ( amount of 5 ° transmitted light in anisotropic diffusion direction , which is measured through goniophotometer ) / ( amount of 5 ° transmitted light in direction perpendicular to anisotropic diffusion direction , which is measured through goniophotometer ) \qquad Equation 1$$

In an embodiment of the disclosure, the ADV of the anisotropic diffusion layer 18 may be 3 or more, 15 or more, or 25 or more.

The anti-reflection film 10″ according to an embodiment of the disclosure is not limited to that illustrated in FIG. 5.

The anti-reflection film 10″ according to an embodiment of the disclosure may have a structure in which a first substrate, an anisotropic diffusion layer 18, a second substrate, the anti-glare layer 16, and a low refractive index layer 17 are sequentially stacked in this stated order. In this case, the anisotropic diffusion layer 18 has adhesiveness, and the first substrate and the second substrate may be bonded to each other with the anisotropic diffusion layer 18 therebetween.

In addition, the anisotropic diffusion layer 18 is not limited to the form including the resin portion 181 and the anisotropic particles 182 illustrated in FIG. 5, as long as the anisotropic diffusion layer 18 may anisotropically diffuse light.

In an embodiment of the disclosure, the anisotropic diffusion layer 18 may include a core layer including vacancies, which are empty holes, and a skin layer for protecting the core layer. In this case, the vacancies within the core layer may be crazes having a substantially linear shape and may be formed by craze processing, etc. The anisotropic diffusion layer 18 having the above-described configuration may contribute to expanding the viewing angle of the anti-reflection film 10 by causing incident light to be anisotropically diffused at the interface between a resin constituting the core layer and the vacancies. As a specific embodiment of the anisotropic diffusion layer 18, examples 1 to 5 disclosed in International Publication No. WO 2019/156003 are provided.

In addition, the anisotropic diffusion layer 18 may have a concavo-convex interface within the layer. The interface may be formed by resins having different refractive indices. The anisotropic diffusion layer 18 having the above-described configuration may contribute to expanding the viewing angle of the anti-reflection film 10 by causing incident light to be anisotropically diffused at the interface.

A specific embodiment of the anisotropic diffusion layer 18 is disclosed in Japanese Patent Application Laid-Open No. 2020-16881.

### Polarizing Plate

The anti-glare layer 16 and the low refractive index layer 17, according to an embodiment of the disclosure, may be used as a surface film of a polarizing plate (or a polarizing member).

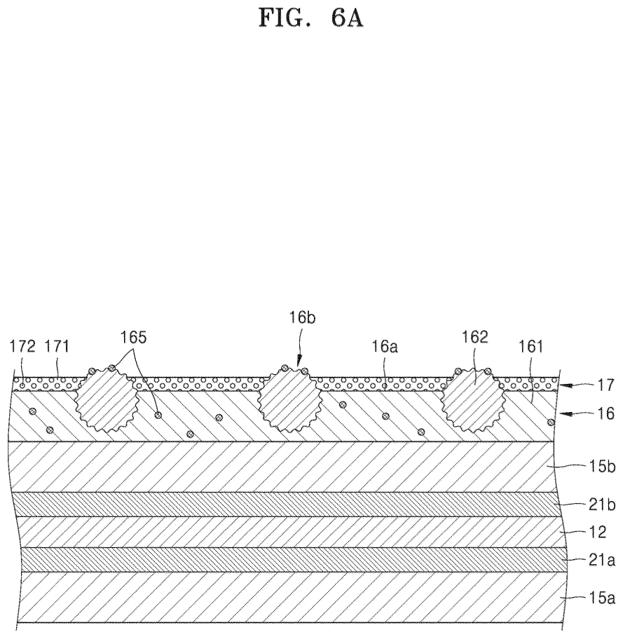

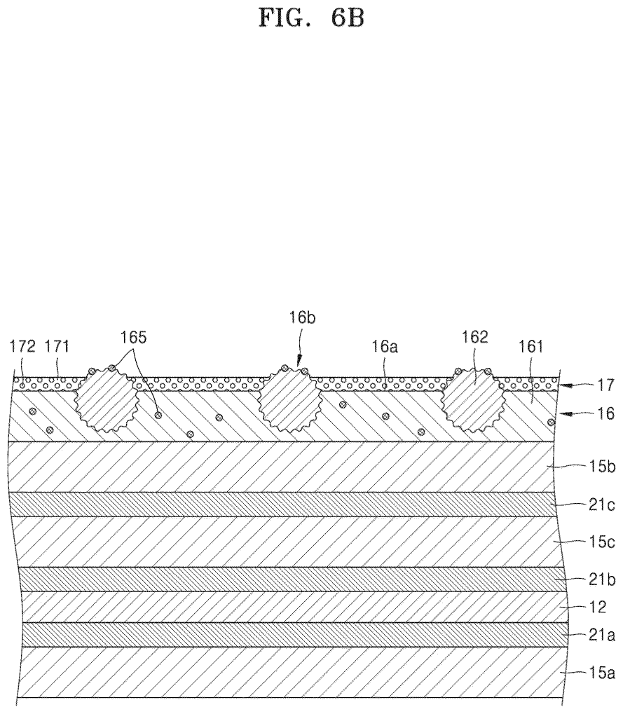

FIGS. 6A and 6B are cross-sectional views schematically illustrating a polarizing plate according to an embodiment of the disclosure. In FIGS. 6A and 6B, the same components as in FIG. 2 are denoted by the same reference numerals, and a redundant description thereof is omitted. The polarizing plate according to an embodiment of the disclosure may include a polarizing film 12 arranged between the substrate and the resin film and configured to polarizes light.

Referring to FIG. 6A, the polarizing plate according to an embodiment of the disclosure may include a first substrate 15a, a first adhesive layer 21a, the polarizing film 12, a second adhesive layer 21b, a second substrate 15b, an anti-glare layer 16, and a low refractive index layer 17, which are sequentially stacked in this stated order. The first substrate 15a and the second substrate 15b may include the same or different materials, and the first adhesive layer 21a and the second adhesive layer 21b may include the same or different materials.

The polarizing film 12 provided on the first substrate 15a may be bonded to the first substrate 15a by the first adhesive layer 21a. A resin film including the second substrate 15b, the anti-glare layer 16, and the low refractive index layer 17 may be provided on the polarizing film 12. That is, the resin film may be bonded to the polarizing film 12 by the second adhesive layer 21b. In an embodiment of the disclosure, the first adhesive layer 21a and the second adhesive layer 21b may each include a UV adhesive, a pressure sensitive adhesive (PSA), an optical clear adhesive (OCA), or an optical clear resin (OCR).

Referring to FIG. 6B, the polarizing plate according to an embodiment of the disclosure may include a first stack structure in which a first substrate 15a, a first adhesive layer 21a, and a polarizing film 12 are sequentially stacked in this stated order, and may include a second stack structure in which a second substrate 15b, an anti-glare layer 16, and a low refractive index layer 17 are sequentially stacked in this stated order on the first stack structure. A third substrate 15c may be provided between the first stack structure and the second stack structure. The third substrate 15c may be bonded to the first stack structure by the second adhesive layer 21b and may be bonded to the second stack structure by a third adhesive layer 21c. In other words, the polarizing plate according to an embodiment of the disclosure may include the first substrate 15a, the first adhesive layer 21a, the polarizing film 12, the second adhesive layer 21b, the third substrate 15c, the third adhesive layer 21c, the second substrate 15b, the anti-glare layer 16, and the low refractive index layer 17, which are sequentially stacked in this stated order. That is, the polarizing plate illustrated in FIG. 6B differs from the polarizing plate illustrated in FIG. 6A in that the polarizing plate illustrated in FIG. 6B further includes the third substrate 15c and the third adhesive layer 21c. In an embodiment of the disclosure, the first adhesive layer 21a and the second adhesive layer 21b may include a UV adhesive, and the third adhesive layer 21c may include a PSA.

In addition, when the anti-glare layer 16 and the low refractive index layer 17 are applied to the polarizing plate, the polarizing plate may further include the high refractive index layer (see 19 of FIG. 4) or the anisotropic diffusion layer (see 18 of FIG. 5) described above.

### Method of Manufacturing Anti-Reflection Film

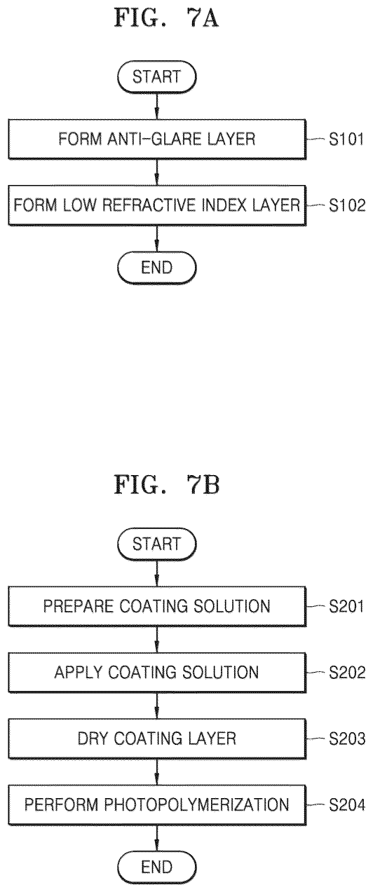

FIG. 7A is a flowchart illustrating a method of manufacturing the anti-reflection film 10, according to an embodiment of the disclosure, and FIG. 7B is a flowchart illustrating a method of manufacturing the anti-glare layer 16 and the low refractive index layer 17, according to an embodiment of the disclosure. Hereinafter, a method of manufacturing the anti-reflection film 10 having the cross-sectional structure illustrated in FIG. 2 is described.

Referring to FIGS. 2 and 7A, the method of manufacturing the anti-reflection film 10, according to an embodiment of the disclosure, may include forming the anti-glare layer 16 on the substrate 15 (S101) and forming the low refractive index layer 17 on the anti-glare layer 16 (S102).

In the forming of the anti-glare layer 16 on the substrate 15 (S101), the anti-glare layer 16 may be formed by coating a coating solution, which serves as the base of the anti-glare layer 16, on the substrate 15.

In the forming of the low refractive index layer 17 on the anti-glare layer 16 (S102), the low refractive index layer 17 may be formed by coating a coating solution, which serves as the base of the low refractive index layer 17, on the anti-glare layer 16. In an embodiment of the disclosure, the low refractive index layer 17 may be formed on the flat portion 16a of the anti-glare layer 16.

The anti-glare layer 16 and the low refractive index layer 17 may be formed by wet coating, as described below.

Referring to FIGS. 2 and 7B, the coating solution for forming the anti-glare layer 16 and the low refractive index layer 17 may be prepared (S201). At this time, the expression that “the coating solution may be prepared” may include not only producing the coating solution, but also purchasing and preparing the coating solution.

The coating solution may include a solid and a solvent.

The solid included in the coating solution for forming the anti-glare layer 16 may include a monomer, an oligomer, and a polymer, which serve as the base of the binder 161. The solid may include the light-scattering particles 162 and the high refractive index nanoparticles 165. The monomer and/or the oligomer may be polymerized to become a resin included in the binder 161. The polymerization may refer to photopolymerization or thermal polymerization. For convenience of explanation, the monomer, the oligomer, and/or the polymer are referred to as a “binder component.”

The solid included in the coating solution for forming the low refractive index layer 17 may include a binder component that serves as the base of the binder 171. The solid may include the hollow silica particles 172 and the surface modifier.

The solid according to an embodiment of the disclosure may include the polymerization initiator and may further include an additive, such as a dispersant, an anti-foaming agent, a UV absorber, or a leveling agent.

The coating solution for the anti-glare layer 16 and the coating solution for the low refractive index layer 17 may be prepared by adding the above-described solid to the solvent and stirring the resulting mixture.

The solvent may disperse the solid. In an embodiment of the disclosure, the solvent may include methylene chloride, toluene, xylene, ethyl acetate, butyl acetate, acetone, diacetone alcohol, methyl ethyl ketone (MEK), methyl isobutyl ketone (MIBK), propyleneglycolmethyl ether acetate (PGME), propylene glycol methyl ether (PGME), ethanol, methanol, n-propyl alcohol, isopropyl alcohol, tert-butyl alcohol, 1-butanol, mineral spirits, oleic acid, cyclohexanone, N-methylpyrrolidone (NMP), dimethyl phthalate (DMP), dimethyl carbonate, or dioxolane.

In an embodiment of the disclosure, the concentration of the solid included in the coating solution may be about 2 mass % to about 80 mass %.

The concentration of the solid included in the coating solution for the anti-glare layer 16 may vary depending on the average particle diameter or the content of each of the light-scattering particles 162 and the high refractive index nanoparticles 165, and the area ratio of the flat portion 16a to the protruding portion 16b in the anti-glare layer 16 and the degree to which the high refractive index nanoparticles 165 are deposited on the light-scattering particles 162 may be controlled to a desired degree.

In addition, the coating solution for the low refractive index layer 17 may have a lower solid concentration than the coating solution for the anti-glare layer 16 so that uniformity of film thickness may be ensured during coating.

Next, a coating layer may be prepared by applying (coating) the coating solution (S202). The coating method is not particularly limited. In an embodiment of the disclosure, the coating method may include die coating or micro gravure coating. In addition, the coating solution may be coated by dropping the coating solution and then rotating to form a layer with uniform thickness by a centrifugal force. The coating solution may be coated in a heated state.

Next, the coated coating layer may be dried (S203). The drying of the coating layer (S203) may include a method of leaving the coating layer at room temperature to evaporate the solvent or a method of forcibly removing the solvent by heating or vacuum treatment.

Next, the photopolymerization (S204) may be performed. In the photopolymerization (S204), energy such as UV light or heat may be radiated onto the coating layer to photopolymerize the binder component in the coating layer.

The anti-glare layer 16 and the low refractive index layer 17 may be manufactured through the processes described above. The drying process and the photopolymerization process may also be referred to as a curing process of curing the coated coating solution.

Hereinafter, a method of manufacturing the anti-reflection film 10′ having the cross-sectional structure illustrated in FIG. 4 is described. For convenience of explanation, a description redundant with the method of manufacturing the anti-reflection film 10 having the cross-sectional structure illustrated in FIG. 2 is omitted.

Referring to FIGS. 4 and 7B, to manufacture the anti-reflection film 10′ having the cross-sectional structure illustrated in FIG. 4, the coating solution may be applied (coated), the coating layer may be dried, and then the anti-glare layer 16 may be formed by photopolymerization, as described above. Thereafter, the high refractive index layer 19 may be formed on the anti-glare layer 16. As described above, the low refractive index layer 17 may be formed on the high refractive index layer 19.

Specifically, the high refractive index layer 19 may be formed by applying (coating) the coating solution, drying the coating layer, radiating energy such as UV light onto the coating layer, and photopolymerizing the binder component included in the high refractive index layer 19.

The coating solution for the high refractive index layer 19 may be prepared by adding the solid to the solvent. In this case, the solid may include a binder, high refractive index particles, and a polymerization initiator, and may further include other additives as necessary.

As described above, the anti-glare layer 16 included in the anti-reflection film 10 may include the binder 161 as a main component, and may include the flat portion 16a having a flat surface shape and the protruding portion 16b where a portion of the light-scattering particles 162 protrude from the surface of the flat portion 16a. The irregularities 163 caused by the light-scattering particles 162 may be formed in the protruding portion 16b, and the high refractive index nanoparticles 165 may be deposited on the irregularities 163.

Because the anti-glare layer 16 has the above-described configuration, anti-glare of the anti-reflection film 10 may be improved. In addition, it is possible to suppress a deterioration in the coating property of the low refractive index layer 17 for the anti-glare layer 16. Therefore, the reflectance may be reduced by the low refractive index layer 17, and the sharpness of the image displayed on the liquid crystal panel (see 1a of FIG. 1B) may be improved.

The anti-reflection film 10 according to the above-described embodiment of the disclosure has a structure in which the anti-glare layer 16 and the low refractive index layer 17 are stacked on the substrate 15, but in an embodiment of the disclosure, the anti-reflection film 10 may not include the substrate 15.

Furthermore, in the above-described embodiment of the disclosure, the case in which the liquid crystal panel 1a or the organic EL panel 1b included in the display device 1 includes the anti-glare layer 16 and the low refractive index layer 17 is provided, but embodiments of the disclosure are not limited thereto. In an embodiment of the disclosure, the display device 1 may include a cathode ray tube, and the cathode ray tube may include the anti-glare layer 16 and the low refractive index layer 17.

In addition, the above-described layers may be formed on a surface of a lens including glass or plastic. In this case, the lens may be the substrate. Accordingly, an optical member according to an embodiment of the disclosure may include the lens, and the anti-glare layer 16 and the low refractive index layer 17, which are formed on the lens.

### EXAMPLES

Hereinafter, the disclosure is described in detail with reference to examples. However, disclosure is not limited to the examples. Unless otherwise stated below, the content is based on mass %.

### Preparation of Coating Solution for Anti-Glare Layer

Hereinafter, a method of preparing a coating solution for an anti-glare layer is described. Coating solutions A-1 to A-16, which served as the base of the anti-glare layer, were prepared according to the compositions shown in Tables 1 and 2 below.

### 1. Coating Solution A-1

The coating solution A-1 includes a binder component, light-scattering particles, high refractive index nanoparticles, a photopolymerization initiator, other additives (an anti-foaming agent, a leveling agent, etc.), and a solvent, which serve as the base of the binder.

As the binder component, UA-306H (refractive index: 1.52) manufactured by Kyoeisha Chemical Co., Ltd. and KAYARAD PET-30 (refractive index: 1.49) manufactured by Nippon Gunyaku Co., Ltd. were used. As the light-scattering particles, Techpolymer MBP series manufactured by Sekisui Chemical Industry Co., Ltd. (PMMA particles with a rough surface. average particle diameter: 4 μm, refractive index: 1.49, silicone oil adsorption amount: 180 ml/100 g) was used. As the high refractive index nanoparticles, Zircostar ZP-153 (zirconia particles with an average primary particle diameter of 12 nm) manufactured by Nihon Shokubai Co., Ltd. was used. As the photopolymerization initiator, Omnirad 184 and Omnirad 907 manufactured by IGM RESINS were used. As the leveling agent, Megapak F-554 manufactured by DIC Corporation was used.

The binder component, the light-scattering particles, the high refractive index nanoparticles, the photopolymerization initiator, and the leveling agent are solids for preparing the coating solution A-1, and the contents thereof are shown in Table 1 below.

The solids were added to a mixture of solvents such as toluene, methyl isobutyl ketone, methyl ethyl ketone, and cyclohexanone, and stirred for 5 minutes by using a dissolver to prepare the coating solution A-1. At this time, the concentration of the solids included in the prepared coating solution A-1 was set to 50 mass %. The contents of toluene, methyl isobutyl ketone, methyl ethyl ketone, and cyclohexanone included in the solvent are shown in Table 1 below.

### 2. Coating Solutions A-2 to A-16

The materials shown in Tables 1 and 2 below were used as solids of the coating solution, that is, a binder component, light-scattering particles and high refractive index nanoparticles, a photopolymerization initiator, and other additives (an anti-foaming agent, a leveling agent, etc.), and were mixed so that the solids had the contents shown in Tables 1 and 2.

These solids were added to a solvent mixture having the contents of toluene, xylene, methyl isobutyl ketone, methyl ethyl ketone, propylene glycol methyl ether, and cyclohexanone as shown in Tables 1 and 2 so as to have the solid concentrations as shown in Tables 1 and 2, and stirred for 5 minutes by using a dissolver to prepare the coating solutions A-2 to A-16.

Hereinafter, the materials used as the solids included in the coating solution are described, excluding the materials described above.

### (1) Binder Component

UA-3061: Manufactured by Kyoeisha Chemical Co., Ltd. Refractive index: 1.52
EBECRYL5129: Manufactured by Daicel Allnex Co., Ltd. Refractive index: 1.52
U-6LPA: Manufactured by Shin-Nakamura Chemical Co., Ltd. Refractive index: 1.51
8-UX-122A: Manufactured by Taisei Fine Chemical Co., Ltd. Refractive index: 1.50
UV-1700B: Manufactured by Mitsubishi Chemical Corporation. Refractive index: 1.52
KAYARAD PET-30: Manufactured by Nippon Gunpowder Co., Ltd. Refractive index: 1.49
Light Acrylate PE-4A: Manufactured by Kyoeisha Chemical Co., Ltd. Refractive index: 1.49
Light acrylate DPE-6A: Manufactured by Kyoeisha Chemical Co., Ltd. Refractive index: 1.49

### (2) Light-Scattering Particles

ART PEARL TE-812T: Manufactured by Sekisui Chemical Industry Co., Ltd. Urethane particles having a rough surface. Average particle diameter: 5.8 μm, refractive index: 1.52, silicone oil adsorption capacity: 150 mL/100 g
MKN03: Manufactured by Nikkorika Co., Ltd. Silicon particles having a rough surface. Average particle diameter: 3.5 μm, refractive index: 1.46, silicone oil adsorption capacity: 95 mL/100 g
MKN02: Manufactured by Nikkorika Co., Ltd. Silicon particles having a rough surface. Average particle diameter: 2.5 μm, refractive index: 1.46, silicone oil adsorption capacity: 100 mL/100 g
Sylophobic 507: Manufactured by Fuji Silicia Chemical Co., Ltd. Silica particles having a rough surface. Average particle diameter: 2.7 μm, refractive index: 1.46, silicone oil adsorption capacity: 110 mL/100 g
Sylysia 350: manufactured by Fuji Silycia Chemical Co., Ltd. Silica particles having a rough surface. Average particle diameter: 3.9 μm, refractive index: 1.46, silicone oil adsorption capacity: 320 mL/100 g
Techpolymer SSX-103: Manufactured by Sekisui Chemical Industry Co., Ltd. Spherical PMMA particles. Average particle diameter: 3.0 μm, refractive index: 1.49, silicone oil adsorption capacity: 60 mL/100 g
MX-80H3wT: Manufactured by Soken Chemical Co., Ltd. Spherical PMMA particles. Average particle diameter: 0.8 μm, refractive index: 1.49, silicone oil adsorption capacity: 66 mL/100 g

### (3) High Refractive Index Nanoparticles, Nanoparticles

Titania sol ND: Manufactured by Teika Co., Ltd. Titanium dioxide particles having an average primary particle diameter of 10 nm
Organosilica sol MIBK-AC-2140Y: Manufactured by Nissan Chemical Corporation. Silica particles having an average primary particle diameter of 12 nm. Refractive index: 1.45

### (4) Photopolymerization Initiator

Omnirad 369: Manufactured by IGM RESINS
Irgacure OXE02: Manufactured by BASF Japan Co., Ltd.

### (5) Other Additives

Megapak F-444: Manufactured by DIC Corporation. Leveling agent
BYK333: Manufactured by ALTANA Anti-foaming agent
BYK3568: Manufactured by ALTANA Anti-foaming agent
BYK3566: Manufactured by ALTANA Anti-foaming agent
Polyflow 85: Manufactured by Kyoeisha Chemical Co., Ltd. Leveling agent
UVX-36: Manufactured by Kusumoto Chemical Co., Ltd. Leveling agent
n-Octyl Acrylate: Manufactured by Osaka Organic Chemical Industry Co., Ltd. Adhesive
AC-303HF: Manufactured by Kyoeisha Chemical Co., Ltd. Leveling agent

TABLE 1

| CLASSIFICATION | | MATERIAL NAME | A-1 | A-2 | A-3 | A-4 | A-5 | A-6 | A-7 | A-8 |
|---|---|---|---|---|---|---|---|---|---|---|
| SOLID | BINDER | UA-306H | 40.0 | — | — | — | — | 30.0 | — | — |
| CONTENT | COMPONENT | UA-306I | — | 27.0 | — | — | — | — | — | — |
| | | EBECRYL5129 | — | — | 75.3 | — | — | — | — | 70.0 |
| | | U-6LPA | — | — | — | 22.0 | — | — | — | — |
| | | 8-UX-122A | — | — | — | — | 30.0 | — | — | — |
| | | UV-1700B | — | — | — | — | — | — | 20.0 | 1 |
| | | KAYARAD PET-30 | 48.1 | 27.3 | — | 51.4 | 29.7 | 30.0 | 53.5 | 12.7 |
| | | LIGHT ACRYLATE PE-4A | — | 10.0 | — | — | — | 21.0 | — | — |
| | | LIGHT ACRYLATE DPE-6A | — | — | — | — | 8.4 | — | — | — |
| | LIGHT- | TECHPOLYMER MBP SERIES | 1.2 | — | — | — | — | 2.7 | — | — |
| | SCATTERING | ART PEARL TE-812T | — | 2.0 | — | — | — | — | — | — |
| | PARTICLES | MKN03 | — | — | 2.5 | — | 4.1 | — | — | 1.8 |
| | | MKN02 | — | — | — | 2.7 | — | — | 2.4 | — |
| | | SYLOPHOBIC 507 | — | — | — | 0.8 | 0.4 | — | 1.1 | — |
| | | CYCILIA 350 | — | — | — | — | — | 1.1 | — | — |
| | | TECHPOLYMER SSX-103 | — | — | — | — | — | — | — | — |
| | | MX-80H3wT | — | — | — | — | — | — | — | — |
| | HIGH | ZIRCOSTAR ZP-153 | 8.0 | 31.0 | 20.0 | 20.0 | 25.0 | — | 20.0 | 13.0 |
| | REFRACTIVE | TITANIA SOL ND | — | — | — | — | — | 13.0 | — | — |
| | INDEX | ORGANOSILICA SOL MIBK- | — | — | — | — | — | — | — | — |
| | NANOPARTICLES | AC-2140Y | | | | | | | | |
| | PHOTOPOLY- | OMNIRAD 184 | 2.0 | 2.0 | 1.0 | 2.0 | — | — | 1.0 | — |
| | MERIZATION | OMNIRAD 369 | — | 0.5 | — | — | — | 2.0 | — | — |
| | INITIATOR | OMNIRAD 907 | 0.5 | — | — | 0.5 | — | — | 1.0 | — |
| | | IRGACURE OXE02 | — | — | 1.0 | — | 2.0 | — | — | 2.0 |
| | OTHERS | MEGAPAK F-554 | 0.20 | — | — | — | — | — | — | — |
| | | MEGAPAK F-444 | — | 0.20 | — | — | — | — | — | — |
| | | BYK333 | — | — | 0.15 | — | — | — | — | — |
| | | BYK3568 | — | — | — | 0.50 | — | — | — | — |
| | | BYK3566 | — | — | — | — | 0.30 | — | — | — |
| | | POLYFLOW 85 | — | — | — | — | — | 0.20 | 1.00 | — |
| | | UVX-36 | — | — | — | — | — | — | — | 0.50 |
| | | n-OCTYL ACRYLATE | — | — | — | — | — | — | — | — |
| | | AC-303HF | — | — | 0.05 | 0.10 | 0.10 | — | — | — |

| TOTAL | | 100 | 100 | 100 | 100 | 100 | 100 | 100 | 100 |
|---|---|---|---|---|---|---|---|---|---|
| SOLVENT | TOLUENE | 50 | — | — | — | — | 60 | — | 50 |
| | XYLENE | — | — | — | — | — | 10 | — | 30 |
| | METHYL ISOBUTYL KETONE | 30 | 70 | 70 | 70 | 70 | 20 | 70 | |
| | METHYL ETHYL KETONE | 10 | 10 | 10 | 10 | 15 | 10 | 10 | 20 |
| | PROPYLENE GLYCOL | — | 20 | 20 | — | — | — | — | — |
| | METHYL ETHER | | | | | | | | |
| | CYCLOHEXANONE | 10 | — | — | 20 | 15 | — | 20 | — |

| | | | | | | | | |
|---|---|---|---|---|---|---|---|---|
| TOTAL | 100 | 100 | 100 | 100 | 100 | 100 | 100 | 100 |
| SOLID CONCENTRATION (wt %) | 50 | 40 | 60 | 45 | 40 | 40 | 45 | 50 |

TABLE 2

| CLASSIFICATION | | MATERIAL NAME | A-9 | A-10 | A-11 | A-12 | A-13 | A-14 | A-15 | A-16 |
|---|---|---|---|---|---|---|---|---|---|---|
| SOLID | BINDER | UA-306H | — | — | — | — | 40.0 | — | — | — |
| CONTENT | COMPONENT | UA-306I | — | 10.0 | — | — | — | — | — | — |
| | | EBECRYL5129 | — | — | 30.0 | — | — | 75.3 | 70.0 | — |
| | | U-6LPA | 38.0 | — | — | 32.6 | — | — | — | 38.0 |
| | | 8-UX-122A | — | 50.0 | — | — | — | — | — | — |
| | | UV-1700B | — | — | — | — | — | — | — | — |
| | | KAYARAD PET-30 | 36.6 | 21.5 | 34.0 | 40.0 | 46.8 | — | 13.0 | 36.6 |
| | | LIGHT ACRYLATE PE-4A | — | — | 10.9 | — | — | — | — | — |
| | | LIGHT ACRYLATE DPE-6A | — | — | — | — | — | — | — | — |
| | LIGHT | TECHPOLYMER MBP SERIES | — | 1.3 | — | — | — | — | — | — |
| | SCATTERING | ART PEARL TE-812T | — | — | — | — | — | — | — | — |
| | PARTICLES | MKN03 | — | — | 2.1 | — | — | 2.5 | — | — |
| | | MKN02 | 2.4 | — | — | 2.1 | — | — | — | 2.4 |
| | | SYLOPHOBIC 507 | — | — | — | 1.0 | — | — | — | — |
| | | CYCILIA 350 | — | — | — | — | — | — | — | — |
| | | TECHPOLYMER SSX-103 | — | — | — | — | 2.5 | — | 1.5 | — |
| | | MX-80H3wT | — | — | 0.7 | — | — | — | — | — |
| | HIGH | ZIRCOSTAR ZP-153 | 20.0 | — | 20.0 | 15.0 | 8.0 | — | 13.0 | — |
| | REFRACTIVE | TITANIA SOL ND | — | 15.0 | — | 5.0 | — | — | — | — |
| | INDEX | ORGANOSILICA SOL MIBK- | — | — | — | — | — | 20.0 | — | 20.0 |
| | NANOPARTICLES | AC-2140Y | | | | | | | | |
| | PHOTOPOLY- | OMNIRAD 184 | 1.5 | — | 1.0 | 1.0 | 2.0 | 1.0 | — | 1.5 |
| | MERIZATION | OMNIRAD 369 | — | 2.0 | 1.0 | — | — | — | — | — |
| | INITIATOR | OMNIRAD 907 | 1.0 | — | — | 1.0 | 0.5 | — | — | 1.0 |
| | | IRGACURE OXE02 | — | — | — | — | — | 1.0 | 2.0 | — |
| | OTHERS | MEGAPAK F-554 | — | 0.20 | — | — | 0.20 | — | — | — |
| | | MEGAPAK F-444 | — | — | — | — | — | — | — | — |
| | | BYK333 | — | — | — | — | — | 0.15 | — | — |
| | | BYK3568 | — | — | — | — | — | — | — | — |
| | | BYK3566 | — | — | — | 2.00 | — | — | — | — |
| | | POLYFLOW 85 | — | — | — | — | — | — | — | — |
| | | UVX-36 | — | — | 0.30 | — | — | — | 0.50 | — |
| | | n-OCTYL ACRYLATE | 0.50 | — | — | 0.30 | — | — | — | 0.50 |
| | | AC-303HF | — | — | — | — | — | 0.05 | — | — |

| TOTAL | | 100 | 100 | 100 | 100 | 100 | 100 | 100 | 100 |
|---|---|---|---|---|---|---|---|---|---|
| SOLVENT | TOLUENE | — | — | — | — | — | 50 | — | — |
| | XYLENE | — | — | — | — | — | — | — | — |
| | METHYL ISOBUTYL KETONE | 60 | 40 | 50 | 90 | 70 | 40 | 50 | 70 |
| | METHYL ETHYL KETONE | 10 | 10 | 10 | 10 | 10 | 10 | 10 | 10 |
| | PROPYLENE GLYCOL | — | 50 | 30 | — | — | — | — | — |
| | METHYL ETHER | | | | | | | | |
| | CYCLOHEXANONE | 30 | — | 10 | — | 20 | — | 40 | 20 |

| | | | | | | | | |
|---|---|---|---|---|---|---|---|---|
| TOTAL | 100 | 100 | 100 | 100 | 100 | 100 | 100 | 100 |
| SOLID CONCENTRATION (wt %) | 35 | 62 | 40 | 40 | 40 | 50 | 50 | 50 |

### Preparation of Coating Solution for Low Refractive Index Layer

Hereinafter, a method of preparing a coating solution for a low refractive index layer is described.

As solids included in the coating solution for the low refractive index layer, a binder component, nanoparticles, a photopolymerization initiator, a surface modifier, and other additives were used. The solids were added to a solvent mixture having the contents of methyl isobutyl ketone, n-butyl alcohol, 1-methoxy-2-propanol, and diacetone alcohol as shown in Table 3 below so as to have the solid concentration as shown in Table 3 below, and stirred for 5 minutes by using a dissolver to prepare coating solutions B-1 to B-6.

The materials and contents used as the solids in each coating solution, the solvent used, and the contents of methyl isobutyl ketone, n-butyl alcohol, 1-methoxy-2-propanol, and diacetone alcohol in the solvent are shown in Table 3 below. The materials used as the solids included in the coating solution are as follows.

### (1) Binder Component

EBECRYL 160S: Manufactured by Daicel Allnex Co., Ltd.
KAYARAD PET-30: Manufactured by Nippon Gunpowder Co., Ltd.
NK Ester A-200: Manufactured by Shin-Nakamura Chemical Co., Ltd.
NK Ester APG-400: Manufactured by Shin-Nakamura Chemical Co., Ltd.
AR-100: Manufactured by Daikin Industries, Ltd.

### (2) Nanoparticles

Hollow silica particles having an average primary particle diameter of 75 nm
Hollow silica particles having an average primary particle diameter of 60 nm
Solid silica particles having an average primary particle diameter of 10 nm

### (3) Photopolymerization Initiator

Omnirad 184: Manufactured by IGM RESINS
Omnirad 907: Manufactured by IGM RESINS

### (4) Surface Modifier

Optool DAC: Manufactured by Daikin Industries, Ltd.
KY-1203: Manufactured by Shin-Etsu Chemical Co., Ltd.
Megapak RS-58: Manufactured by Daikin Industries, Ltd.
Megapak RS-90: Manufactured by Daikin Industries, Ltd.
Ftergent 650A: Neos Corporation

### (5) Other Additives

BYK-066N: Manufactured by ALTANA Anti-foaming agent

TABLE 3

| CLASSIFICATION | | MATERIAL NAME | B-1 | B-2 | B-3 | B-4 | B-5 | B-6 |
|---|---|---|---|---|---|---|---|---|
| SOLID | BINDER | EBECRYL160S | 9 | 9 | 9 | 6 | — | — |
| CONTENT | COMPONENT | KAYARAD PET-30 | 17 | — | — | — | — | 9 |
| | | NK ESTER A-200 | — | 17 | — | 10 | 19 | 16 |
| | | NK ESTER APG-400 | — | — | 17 | — | — | — |
| | | AR-100 | — | — | — | — | 10 | — |
| | SILICA | HOLLOW SILICA FINE PARTICLES | 47.0 | 47.0 | 47.0 | 47.0 | 46.5 | — |
| | PARTICLES | (AVERAGE PRIMARY PARTICLE | | | | | | |
| | | SIZE: 75 nm) | | | | | | |
| | | HOLLOW SILICA FINE PARTICLES | — | — | — | — | — | 48.0 |
| | | (AVERAGE PRIMARY PARTICLE | | | | | | |
| | | SIZE: 60 nm) | | | | | | |
| | | HOLLOW SILICA FINE PARTICLES | 15.0 | 15.0 | 14.0 | 15.0 | 12.5 | 10.0 |
| | | (AVERAGE PRIMARY PARTICLE | | | | | | |
| | | SIZE: 10 nm) | | | | | | |
| | PHOTOPOLY- | OMNIRAD 184 | 1.99 | 1.99 | 2.00 | 1.99 | 1.00 | 1.00 |
| | MERIZATION | OMNIRAD 907 | — | — | — | — | 0.99 | 0.99 |
| | INITIATOR | | | | | | | |
| | SURFACE | OPTOOL DAC | 5 | — | 5 | — | — | — |
| | MODIFIER | KY-1203 | 5 | 5 | — | 15 | 5 | 10 |
| | | MEGAPAK RS-58 | — | 5 | — | 5 | 5 | — |
| | | MEGAPAK RS-90 | — | — | 5 | — | — | 5 |
| | | FTERGENT 650A | — | — | 1 | — | — | — |
| | OTHERS | BYK-066N(ALTANA) | 0.01 | 0.01 | — | 0.01 | 0.01 | 0.01 |

| TOTAL | | 100 | 100 | 100 | 100 | 100 | 100 |
|---|---|---|---|---|---|---|---|
| SOLVENT | METHYL ISOBUTYL KETONE | 80 | 20 | 70 | 20 | 80 | 80 |
| | n-BUTYL ALCOHOL | 20 | 5 | 20 | — | 10 | 10 |
| | 1-METHOXY-2-PROPANOL | — | 70 | 10 | — | 10 | 10 |
| | DIACETONE ALCOHOL | — | — | — | 80 | — | — |

| | | | | | | |
|---|---|---|---|---|---|---|
| SOLID CONCENTRATION (wt %) | 3 | 3 | 3 | 3 | 3 | 3 |

### Preparation of Coating Solution for High Refractive Index Layer

Next, a method of preparing a coating solution for a high refractive index layer is described.

As solids included in the coating solution for the high refractive index layer, a binder component, nanoparticles, a photopolymerization initiator, and other additives were used. The solids were added to a solvent mixture and stirred for 5 minutes by using a dissolver to prepare coating solutions C-1 to C-4.

The materials and contents used as the solids in each coating solution, the solvent used, and the contents of methyl isobutyl ketone, methyl ethyl ketone, and 1-butanol in the solvent are shown in Table 4 below. The materials used as the solids included in the coating solution are as follows.

### (1) Binder Component

KAYARAD PET-30: Manufactured by Nippon Gunpowder Co., Ltd.
Light Acrylate PE-4A: Manufactured by Kyoeisha Chemical Co., Ltd.
KAYARAD PET-30: Manufactured by Nippon Gunpowder Co., Ltd.

### (2) Nanoparticles

Nanoparticles of zirconia oxide (high refractive index particles): Average primary particle diameter of 7 nm
Nanoparticles of zirconia oxide (high refractive index particles): Average primary particle diameter of 15 nm
Titania nanoparticles: Average primary particle diameter of 15 nm

### (3) Photopolymerization Initiator

Omnirad 184: Manufactured by IGM RESINS
Omnirad 907: Manufactured by IGM RESINS

### (4) Other Additives

Megapak F-568: Manufactured by DIC Corporation. Leveling agent
BYK333: Manufactured by ALTANA Anti-foaming agent
Polyflow 85: Manufactured by Kyoeisha Chemical Co., Ltd. Leveling agent

TABLE 4

| CLASSIFICATION | | MATERIAL NAME | C-1 | C-2 | C-3 | C-4 |
|---|---|---|---|---|---|---|
| SOLID | BINDER | KAYARAD PET-30 | 10 | 5 | 10 | 10 |
| CONTENT | COMPONENT | LIGHT ACRYLATE PE-4A | 28 | 13 | 33 | 33 |
| | | KAYARAD DPHA | — | 5 | — | 10 |
| | NANOPARTICLES | ZIRCONIA OXIDE (AVERAGE PRIMARY | — | 15 | — | — |
| | | PARTICLE SIZE 7 nm) | | | | |
| | | ZIRCONIA OXIDE (AVERAGE PRIMARY | 60 | 65 | 55 | — |
| | | PARTICLE SIZE 15 nm) | | | | |
| | | TITANIA (AVERAGE PRIMARY | — | — | — | 45 |
| | | PARTICLE SIZE 15 nm) | | | | |
| | PHOTOPOLY- | OMNIRAD 184 | 1.0 | 1.0 | 1.8 | 1.8 |
| | MERIZATION | OMNIRAD 907 | 0.8 | 0.9 | — | — |
| | INITIATOR | | | | | |
| | OTHERS | MEGAPAK F-568 | 0.2 | — | — | 0.2 |
| | | BYK333 | — | 0.1 | — | — |
| | | POLYFLOW 85 | — | — | 0.2 | — |

| TOTAL | | 100 | 105 | 100 | 100 |
|---|---|---|---|---|---|
| SOLVENT | METHYL ISOBUTYL KETONE | 70 | 60 | 70 | 70 |
| | METHYL ETHYL KETONE | 20 | 40 | 20 | 20 |
| | 1-BUTANOL | 10 | — | 10 | 10 |

| | | | | |
|---|---|---|---|---|
| SOLID CONCENTRATION (wt %) | 9 | 9 | 9 | 9 |

### Manufacturing of Anti-Reflection Film

An anti-reflection film was manufactured by using each coating solution prepared as described above.

### 1. Example 1

A coating solution A-1 for an anti-glare layer was coated on a triacetyl cellulose substrate Fujitak (manufactured by Fujifilm Corporation, film thickness: 60 μm) by using a wire bar and dried by heating at 90° C. for 2 minutes. An anti-glare layer was formed by radiating a UV lamp (high-pressure mercury lamp, illuminance: 100 mW/cm²) for 4 seconds. As a result, the anti-glare layer having a thickness of 2.0 μm was formed on the substrate.

A coating solution B-1 for a low refractive index layer was coated on the formed anti-glare layer by using a wire bar and dried by heating at 80° C. for 1 minute. The coating solution B-1 was cured by radiating a UV lamp (high-pressure mercury lamp, illuminance: 100 mW/cm²) for 3 seconds under a nitrogen gas atmosphere (oxygen concentration less than 0.1%). As a result, a low refractive index layer having a thickness of 100 nm was formed on the anti-glare layer.

As described above, an anti-reflection film in which the substrate, the anti-glare layer, and the low refractive index layer were sequentially stacked in this stated order was manufactured.

### 2. Examples 2 to 7 and Comparative Examples 1 and 2

The manufacturing method is the same as Example 1, except that the coating solution A-1 for the anti-glare layer and the coating solution B-1 for the low refractive index layer are the coating solutions shown in Tables 5 and 6 below.

The thickness of the anti-glare layer and the thickness of the low refractive index layer in the manufactured anti-reflection film are shown in Tables 5 and 6 below.

### 3. Example 8

An anti-glare layer was formed on a substrate in the same manner as in Example 1 by using a coating solution A-1 for an anti-glare layer. Then, a coating solution C-1 for a high refractive index layer was coated on the anti-glare layer by using a wire bar and dried by heating at 90° C. for 1 minute. A high refractive index layer was formed by radiating a UV lamp (high-pressure mercury lamp, illuminance: 100 mW/cm²) for 4 seconds. Then, a low refractive index layer was formed on the high refractive index layer in the same manner as in Example 1 by using a coating solution B-1 for a low refractive index layer.

As described above, an anti-reflection film in which the substrate, the anti-glare layer, the high refractive index layer, and the low refractive index layer were sequentially stacked in this stated order was manufactured. In the manufactured anti-reflection film, the thickness of the anti-glare layer was 1.9 μm, the thickness of the high refractive index layer was 155 nm, and the thickness of the low refractive index layer was 100 nm.

### 4. Examples 9 to 12 and Comparative Examples 3 and 4

An anti-reflection film in which a substrate, an anti-glare layer, a high refractive index layer, and a low refractive index layer were sequentially stacked in this stated order was manufactured. Specifically, the manufacturing method is the same as Example 8, except that the coating solution A-1 for the anti-glare layer, the coating solution C-1 for the high refractive index layer, and the coating solution B-1 for the low refractive index layer are the coating solutions shown in Table 6 below.

The thickness of the anti-glare layer and the thickness of the low refractive index layer in the manufactured anti-reflection film are shown in Table 6 below.

### Evaluation Method

The following items were evaluated for the anti-reflection films manufactured in Examples 1 to 12 and Comparative Examples 1 to 4.

### 1. Thickness of Anti-Glare Layer

The thickness of the anti-glare layer was measured. Specifically, the thickness of the flat portion of the anti-glare layer was measured by observing the cross-section of the anti-glare layer of the anti-reflection film at a magnification of 2,000 times by using an SEM (SU8600) manufactured by Hitachi High-Technologies Co., Ltd. At this time, the thicknesses were measured at n=20 points within the same sample, and an average of the measured values was adopted.

### 2. Refractive Indices and Thicknesses of Low Refractive Index Layer and High Refractive Index Layer

The refractive indices and thicknesses of the low refractive index layer and the high refractive index layer were measured by using a spectroscopic ellipsometer (VUV-VASE) manufactured by J. W. Woollam. At this time, the thicknesses were measured at n=3 points within the same sample, and an average of the measured values was adopted.

### 3. Haze Value

The haze value of the anti-reflection film was measured by using a haze meter NDH8000 manufactured by Nippon Denshoku Kogyo Co., Ltd. in accordance with JIS K7136:2000. At this time, the haze values were measured at n=3 points within the same sample, and an average of the measured values was adopted.

### 4. Gloss Values at Incident Angles of 20° and 60°

The gloss values of the anti-reflection film were measured at incident angles of 20° and 60°. Specifically, a black PET film (Cookierimieru (trade name), manufactured by Tomoegawa Corporation) was attached to the back surface (substrate) of the anti-reflection film, and the gloss values were measured by using a gloss meter PG-IIM manufactured by Nippon Denshoku Kogyo Co., Ltd. when light was incident on the surface of the anti-reflection film at incident angles of 20° and 60°. At this time, the gloss values were measured at n=3 points within the same sample, and an average of the measured values was adopted.

As the gloss value decrease, anti-glare becomes better.

5. SCI Reflectance and Reflectance Chromaticity (a*/b*)

The SCI reflectance and reflectance chromaticity (a*/b*) of the anti-reflection film were measured. Specifically, a black PET film (Cookierimieru (trade name), manufactured by Tomoegawa Corporation) was attached to the back surface (substrate) of the anti-reflection film, and the SCI reflectance and reflection chromaticity (a*/b*) of the anti-reflection film 10 were measured by using a spectrophotometer CM-26dG manufactured by Konica Minolta Corporation. At this time, the SCI reflectance and reflectance chromaticity (a*/b*) were measured at n=3 points within the same sample, and an average value of the measured values was adopted.

A smaller SCI reflectance of the anti-reflection film is better, and a smaller absolute value of the reflection chromaticity (a*/b*) of the anti-reflection film is better.

### 6. Evaluation of External Light Mirroring on Display

Whether external light was mirrored on the display was evaluated. At this time, an anti-reflection film was bonded to a 55-inch display S95C (manufactured by Samsung Electronics Co., Ltd.) by using an adhesive film. An incandescent lamp was arranged 2 m away from the display at an angle of 45°. Whether an incandescent light bulb was mirrored on the display and the visibility of the image displayed on the display were evaluated by visually observing the display from a distance of 1 m in the front direction of the display while the display was turned on to display an image.

The evaluation was conducted based on the following criteria.
A: Because the degree to which external light is mirrored is very small, the visibility of the image is excellent.
B: Although external light is slightly mirrored, the effect on the visibility of the image is insignificant.
C: Because external light is mirrored, a deterioration in the visibility of the displayed image is confirmed.
D: Because the degree to which external light is mirrored is sever, the visibility of the image is poor.

When the evaluation was A or B, it was considered as a pass, and when the evaluation was C or D, it was considered as a fail.

### 7. Appearance Evaluation

The appearance of the display with the anti-reflection film was evaluated by observing the display with the naked eye under a bright field condition with an illumination of 600 Lux. The display used was the same as the display used to evaluate whether external light was mirrored. The observation of the appearance of the display was conducted in a turned-off state.

The evaluation was conducted based on the following criteria.
A: It feels like a glossless black color.
B: It feels like a slightly glossy black color.
C: It feels like a slight white color due to scattered light.
D: It feels like a white color due to scattered light.

When the evaluation was A or B, it was considered as a pass, and when the evaluation was C or D, it was considered as a fail.

### 8. Evaluation Results

The evaluation results of the anti-reflection films manufactured in Examples 1 to 12 and Comparative Examples 1 to 4 are shown in Tables 5 and 6 below.

TABLE 5

| | | EXAMPLE 1 | EXAMPLE 2 | EXAMPLE 3 | EXAMPLE 4 |
|---|---|---|---|---|---|
| COATING | ANTI-GLARE LAYER | A-1 | A-2 | A-3 | A-4 |
| SOLUTION | HIGH REFRACTIVE INDEX | — | — | — | — |
| | LAYER | | | | |
| | LOW REFRACTIVE INDEX | B-1 | B-2 | 8-3 | B-4 |
| | LAYER | | | | |
| LAYER | ANTI-GLARE LAYER (μM) | 2.0 | 3.0 | 1.8 | 1.5 |
| THICKNESS | HIGH REFRACTIVE INDEX | — | — | — | — |
| | LAYER (μM) | | | | |
| | LOW REFRACTIVE INDEX | 100 | 96 | 98 | 98 |
| | LAYER (μM) | | | | |
| REFRACTIVE | HIGH REFRACTIVE INDEX | — | — | — | — |
| INDEX | LAYER | | | | |
| | LOW REFRACTIVE INDEX | 1.310 | 1.310 | 1.305 | 1.295 |
| | LAYER | | | | |
| EVALUATION | HAZE (%) | 8 | 11 | 17 | 20 |
| RESULTS | GLOSS VALUE (20°) | 1.5 | 1.0 | 0.6 | 0.5 |
| | GLOSS VALUE (60°) | 15.0 | 12.0 | 10.0 | 9.5 |
| | SCI (REFLECTIVITY) | 0.58 | 0.66 | 0.55 | 0.50 |
| | REFLECTION | 4.1/−5.1 | 4.0/−3.5 | 4.0/−4.0 | 3.9/−4.5 |
| | CHROMATICITY (a*/b*) | | | | |
| | OVERLAP EVALUATION | B | B | A | A |
| | APPEARANCE | A | A | A | A |
| | EVALUATION | | | | |
| | | EXAMPLE 5 | EXAMPLE 6 | EXAMPLE 7 | EXAMPLE 8 |
| COATING | ANTI-GLARE LAYER | A-5 | A-6 | A-7 | A-8 |
| SOLUTION | HIGH REFRACTIVE INDEX | — | — | — | C-1 |
| | LAYER | | | | |
| | LOW REFRACTIVE INDEX | B-5 | B-6 | B-5 | B-1 |
| | LAYER | | | | |
| LAYER | ANTI-GLARE LAYER (μM) | 1.5 | 2.0 | 1.5 | 1.9 |
| THICKNESS | HIGH REFRACTIVE INDEX | — | — | — | 155 |
| | LAYER (μM) | | | | |
| | LOW REFRACTIVE INDEX | 100 | 98 | 98 | 100 |
| | LAYER (μM) | | | | |
| REFRACTIVE | HIGH REFRACTIVE INDEX | — | — | — | 1.700 |
| INDEX | LAYER | | | | |
| | LOW REFRACTIVE INDEX | 1.285 | 1.305 | 1.285 | 1.310 |
| | LAYER | | | | |
| EVALUATION | HAZE (%) | 31 | 25 | 23 | 12 |
| RESULTS | GLOSS VALUE (20°) | 0.3 | 0.5 | 0.7 | 0.7 |
| | GLOSS VALUE (60°) | 7.0 | 8.9 | 11.5 | 9.5 |
| | SCI (REFLECTIVITY) | 0.64 | 0.70 | 0.70 | 0.55 |
| | REFLECTION | 3.9/−5.5 | 4.2/−4.3 | 3.8/−4.0 | 0.8/−2.8 |
| | CHROMATICITY (a*/b*) | | | | |
| | OVERLAP EVALUATION | A | A | B | A |
| | APPEARANCE | A | B | B | A |
| | EVALUATION | | | | |

TABLE 6

| | | | | | | COMPARATIVE |
|---|---|---|---|---|---|---|
| | | EXAMPLE 9 | EXAMPLE 10 | EXAMPLE 11 | EXAMPLE 12 | EXAMPLE 1 |
| COATING | ANTI-GLARE LAYER | A-9 | A-10 | A-11 | A-12 | A-13 |
| SOLUTION | HIGH REFRACTIVE INDEX | C-1 | C-2 | C-3 | C-4 | — |
| | LAYER | | | | | |
| | LOW REFRACTIVE INDEX | B-2 | B-5 | B-3 | B-4 | B-1 |
| | LAYER | | | | | |
| LAYER | ANTI-GLARE LAYER (μM) | 1.4 | 2.0 | 1.8 | 1.4 | 1.4 |
| THICKNESS | HIGH REFRACTIVE INDEX | 150 | 155 | 150 | 150 | — |
| | LAYER (μM) | | | | | |
| | LOW REFRACTIVE INDEX | 98 | 100 | 98 | 98 | 98 |
| | LAYER (μM) | | | | | |
| REFRACTIVE | HIGH REFRACTIVE INDEX | 1.700 | 1.740 | 1.670 | 1.700 | — |
| INDEX | LAYER | | | | | |
| | LOW REFRACTIVE INDEX | 1.310 | 1.285 | 1.305 | 1.295 | 1.310 |
| | LAYER | | | | | |
| EVALUATION | HAZE (%) | 14 | 8 | 16 | 18 | 20 |
| RESULTS | GLOSS VALUE (20°) | 0.6 | 1.2 | 1.0 | 0.7 | 2.2 |
| | GLOSS VALUE (60°) | 9.2 | 14.5 | 11.0 | 10.0 | 20.1 |
| | SCI (REFLECTIVITY) | 0.45 | 0.39 | 0.65 | 0.58 | 0.72 |
| | REFLECTION | 0.2/−1.9 | 1.2/−3.1 | −0.5/−0.8 | 0.8/−1.8 | 4.0/−4.1 |
| | CHROMATICITY (a*/b*) | | | | | |
| | OVERLAP EVALUATION | A | B | B | A | D |
| | APPEARANCE | A | A | A | A | C |
| | EVALUATION | | | | | |

| | | COMPARATIVE | COMPARATIVE | COMPARATIVE |
|---|---|---|---|---|
| | | EXAMPLE 2 | EXAMPLE 3 | EXAMPLE 4 |
| COATING | ANTI-GLARE LAYER | A-14 | A-15 | A-16 |
| SOLUTION | HIGH REFRACTIVE INDEX | — | C-1 | C-1 |
| | LAYER | | | |
| | LOW REFRACTIVE INDEX | B-2 | B-1 | B-2 |
| | LAYER | | | |
| LAYER | ANTI-GLARE LAYER (μM) | 1.8 | 1.5 | 1.7 |
| THICKNESS | HIGH REFRACTIVE INDEX | — | 155 | 150 |
| | LAYER (μM) | | | |
| | LOW REFRACTIVE INDEX | 98 | 100 | 98 |
| | LAYER (μM) | | | |
| REFRACTIVE | HIGH REFRACTIVE INDEX | — | 1.700 | 1.700 |
| INDEX | LAYER | | | |
| | LOW REFRACTIVE INDEX | 1.310 | 1.310 | 1.310 |
| | LAYER | | | |
| EVALUATION | HAZE (%) | 18 | 11 | 16 |
| RESULTS | GLOSS VALUE (20°) | 1.7 | 2.2 | 1.7 |
| | GLOSS VALUE (60°) | 16.5 | 22.1 | 20.1 |
| | SCI (REFLECTIVITY) | 0.68 | 0.65 | 0.85 |
| | REFLECTION | 4.1/−3.8 | 0.5/−1.3 | 0.8/−2.5 |
| | CHROMATICITY (a*/b*) | | | |
| | OVERLAP EVALUATION | C | D | D |
| | APPEARANCE | C | C | D |
| | EVALUATION | | | |

As shown in Tables 5 and 6, in the anti-reflection films according to Examples 1 to 12, the results of the external light mirroring evaluation and the appearance evaluation are both A or B, which correspond to the pass range. In addition, in each of the anti-reflection films according to Examples 1 to 12, it was confirmed that the plurality of high refractive index nanoparticles were deposited on the irregularities of the light-scattering particles.

In contrast, in the anti-reflection films according to Comparative Examples 1 and 3, which had no irregularities on the surfaces of the light-scattering particles included in the anti-glare layer, the results of the external light mirroring evaluation and the appearance evaluation both corresponded to the fail range. In addition, in the anti-reflection films according to Comparative Examples 2 and 4, in which the nanoparticles included in the anti-glare layer had a refractive index of 1.45 rather than a high refractive index, the results of the external light mirroring evaluation and the appearance evaluation both corresponded the fail range.

The resin film according to an aspect of the disclosure may include an anti-glare layer and a low refractive index layer. The low refractive index layer may be provided on the anti-glare layer. The anti-glare layer may include a binder and light-scattering particles having irregularities on a surface thereof. The anti-glare layer may include a flat portion and a protruding portion where some of the light-scattering particles protrude from the flat portion. High refractive index nanoparticles may be deposited on the irregularities of the light-scattering particles. According to an aspect of the disclosure, the resin film having excellent anti-glare and low reflectance may be provided.

In an embodiment of the disclosure, a refractive index of the high refractive index nanoparticles may be greater than or equal to 1.60 and less than 2.50, and a refractive index of the low refractive index layer may be less than 1.40. In this case, the light scattering property of the resin film may be improved.

In an embodiment of the disclosure, the anti-glare layer may further include high refractive index nanoparticles that are not deposited on the irregularities. In this case, the resin film may have excellent anti-glare and low reflectance.

In an embodiment of the disclosure, an average particle diameter of the light-scattering particles may be about 1 μm to about 5 μm, and an average particle diameter of the high refractive index nanoparticles 165 may be about 5 nm to about 100 nm. In this case, the light scattering property of the resin film may be improved.

In an embodiment of the disclosure, a refractive index of the light-scattering particles 162 may be about 1.42 to about 1.60. In this case, the light scattering property of the resin film may be improved.

In an embodiment of the disclosure, the high refractive index nanoparticles may include one or more selected from alumina, zirconia, and titania. In this case, the light scattering property of the resin film may be improved.

In an embodiment of the disclosure, an inner haze value of the anti-glare layer may be 2.5% or less. In this case, the reflectance may be reduced by preventing unnecessary scattering within the anti-glare layer of the resin film.

In an embodiment of the disclosure, a gloss value of the anti-glare layer may be 10 or less, as measured from the low refractive index layer side when light is incident on the surface of the anti-glare layer at an incident angle of 20°. In this case, the resin film may have an excellent optical refractive index layer.

In an embodiment of the disclosure, a gloss value of the anti-glare layer may be 45 or less, as measured from the low refractive index layer side when light is incident on the surface of the anti-glare layer at an incident angle of 60°. In this case, the resin film may have an excellent optical refractive index layer.

In an embodiment of the disclosure, the resin film may further include a high refractive index layer between the anti-glare layer and the low refractive index layer. In this case, due to the retardation between the low refractive index layer and the high refractive index layer, the reflectance of the resin film may be reduced and the chromaticity thereof may be greatly improved.

In an embodiment of the disclosure, the refractive index of the high refractive index layer may be about 1.65 to about 1.80. In this case, the light scattering property of the resin film may be improved.

A display device according to an aspect of the disclosure may include a display displaying an image, and the display may include the above-described resin film. According to an aspect of the disclosure, the display with excellent anti-glare and low reflectance may be provided.

An optical member according to an aspect of the disclosure may include a substrate and the above-described resin film formed on the substrate. According to an aspect of the disclosure, the optical member with excellent anti-glare and low reflectance may be provided.

In an embodiment of the disclosure, the optical member may further include an anisotropic diffusion layer arranged between the substrate and the resin film and configured to anisotropically diffuse light. In this case, the optical member may have excellent anti-glare and low reflectance.

In an embodiment of the disclosure, the optical member may further include a polarizing film arranged between the substrate and the resin film and configured to polarize light. In this case, the optical member may have excellent anti-glare and low reflectance.

A method of manufacturing a resin film, according to an aspect of the disclosure, may include forming an anti-glare layer including a flat portion and a protruding portion, in which a portion of light-scattering particles protrudes from the flat portion, by coating, on a substrate, a first coating solution including the light-scattering particles having irregularities on surfaces thereof, high refractive index nanoparticles, and a first binder component, and forming a low refractive index layer by coating, on the anti-glare layer, a second coating solution including hollow silica particles and a second binder component. In this case, the resin film having excellent anti-glare and low reflectance may be manufactured.

In an embodiment of the disclosure, a refractive index of the high refractive index nanoparticles may be greater than or equal to 1.60 and less than 2.50, and a refractive index of the low refractive index layer may be less than 1.40.

In an embodiment of the disclosure, an average particle diameter of the light-scattering particles 162 may be about 1 μm to about 5 μm, and an average particle diameter of the high refractive index nanoparticles 165 may be about 5 nm to about 100 nm.

In an embodiment of the disclosure, a refractive index of the light-scattering particle may be about 1.42 to about 1.60.

The technical effects to be achieved by the disclosure are not limited to those described above, and other technical effects that are not mentioned herein will be clearly understood by those of ordinary skill in the art from the description of the disclosure.

As described above, although the resin film, and the optical member and the display device each including the resin film, according to the disclosure, have been described by limited embodiments of the disclosure and drawings, the disclosure is not limited to the above-described embodiments, and various modifications are possible without departing from the scope thereof.

What is claimed is:

1. A resin film comprising:
an anti-glare layer comprising:
a binder;
light-scattering particles partially disposed in and protruding from the binder, the light-scattering particles having irregularities on surfaces thereof; and
high refractive index nanoparticles on the irregularities on portions of the surfaces the light-scattering particles protruding from the binder; and
a low refractive index layer on the anti-glare layer,
wherein a surface of the anti-glare layer comprises flat portions and protruding portions where the portions of the light-scattering particles protrude from the flat portions.

2. The resin film of claim 1, wherein a refractive index of the high refractive index nanoparticles is greater than or equal to 1.60 and less than 2.50, and
wherein a refractive index of the low refractive index layer is less than 1.40.

3. The resin film of claim 1, further comprising second high refractive index nanoparticles dispersed in the binder wherein the anti-glare layer further comprises high refractive index nanoparticles dispersed in the binder.

4. The resin film of claim 1, wherein an average particle diameter of the light-scattering particles is about 1 μm to about 5 μm, and
wherein an average particle diameter of the high refractive index nanoparticles is about 5 nm to about 100 nm.

5. The resin film of claim 1, wherein a refractive index of the light-scattering particles is about 1.42 to about 1.60.

6. The resin film of claim 1, wherein the high refractive index nanoparticles comprise at least one of alumina, zirconia, and titania.

7. The resin film of claim 1, wherein an inner haze value of the anti-glare layer is less than or equal to 2.5%.

8. The resin film of claim 1, wherein a gloss value of the anti-glare layer is less than or equal to 10, as measured from a side of the anti-glare layer at which the low refractive index layer is provided, when light is incident on the surface of the anti-glare layer at an incident angle of 20°.

9. The resin film of claim 1, wherein a gloss value of the anti-glare layer is less than or equal 45, as measured from a side of the anti-glare layer on which the low refractive index layer is provided, when light is incident on the surface of the anti-glare layer (at an incident angle of 60°.

10. The resin film of claim 1, further comprising a high refractive index layer between the anti-glare layer and the low refractive index layer.

11. The resin film of claim 10, wherein a refractive index of the high refractive index layer is about 1.65 to about 1.80.

12. The resin film of claim 1, wherein the portions of the light-scattering particles extend and protrude through the low refractive index layer.

13. A display device comprising:
a display configured to display an image and comprising a resin film,
wherein the resin film comprises:
an anti-glare layer comprising:
a binder;
light-scattering particles partially disposed in and protruding from the binder, the light-scattering particles having irregularities on surfaces thereof; and
high refractive index nanoparticles on the irregularities on portions of the surfaces the light-scattering particles protruding from the binder; and
a low refractive index layer on the anti-glare layer, and
wherein a surface of the anti-glare layer comprises flat portions and protruding portions where the portions of the light-scattering particles protrude from the flat portions.

14. An optical member comprising:
a substrate; and
a resin film on the substrate,
wherein the resin film comprises:
an anti-glare layer comprising:
a binder;
light-scattering particles partially disposed in and protruding from the binder, the light-scattering particles having irregularities on surfaces thereof; and
high refractive index nanoparticles on the irregularities on portions of the surfaces the light-scattering particles protruding from the binder; and
a low refractive index layer on the anti-glare layer, and
wherein a surface of the anti-glare layer comprises flat portions and protruding portions where the portions of the light-scattering particles protrude from the flat portions.

15. The optical member of claim 14, further comprising an anisotropic diffusion layer between the substrate and the resin film and configured to anisotropically diffuse light.

16. The optical member of claim 14, further comprising a polarizing film between the substrate and the resin film and configured to polarize light.
